(19) United States
(12) Patent Application Publication
(10) Pub. No.: US 2022/0215431 A1
(43) Pub. Date: Jul. 7, 2022

(54) SOCIAL NETWORK OPTIMIZATION

(71) Applicant: Meta Platforms, Inc., Menlo Park, CA (US)

(72) Inventors: Sammy El Ghazzal, Oberengstringen (CH); Rakesh Ravuru, San Jose, CA (US); Ruben Naeff, Brooklyn, NY (US); Yinglong Xia, San Jose, CA (US); Yan Zhu, Foster City, CA (US)

(21) Appl. No.: 17/702,663

(22) Filed: Mar. 23, 2022

Related U.S. Application Data
(60) Provisional application No. 63/166,891, filed on Mar. 26, 2021.
(60) Provisional application No. 63/189,580, filed on May 17, 2021.
(60) Provisional application No. 63/219,638, filed on Jul. 8, 2021.
(60) Provisional application No. 63/241,983, filed on Sep. 8, 2021.

(51) Int. Cl. G06Q 30/02

(52) U.S. Cl. CPC G06Q 30/0255; G06Q 30/0208

(57) ABSTRACT

In one embodiment, a computing system may access first data associated with a first user. The system may determine, based on the first data associated with the first user, a number of content recommendations for the first users. The content recommendations may be associated with one or more interests or one or more operations of the first user. The system may execute one or more operations associated with the content recommendations. The one or more operations may cause one or more contents to be displayed to the first user.

### PRIORITY

This application claims the benefit under 35 U.S.C. § 119(e) of U.S. Provisional Patent Application No. 63/166,891, filed 26 Mar. 2021, U.S. Provisional Patent Application No. 63/189,580, filed 17 May 2021, U.S. Provisional Patent Application No. 63/219,638, filed 8 Jul. 2021, U.S. Provisional Patent Application No. 63/241,983, filed 8 Sep. 2021, which are incorporated herein by reference.

### TECHNICAL FIELD

This disclosure generally relates to advertisement targeting techniques within a social network.

### BRIEF DESCRIPTION OF THE DRAWINGS

FIG. 1 illustrates an example method for a reverse advertisement targeting technique.

FIG. 2 illustrates an example method for grouping a plurality of tabs based on content of the tabs and interaction contexts of a user with the tabs.

FIG. 3 illustrates an example view of an embedding space.

FIG. 4 illustrates an example artificial neural network.

FIG. 5 illustrates an example of similarities between media items for a given user.

FIG. 6 illustrates an example method for evaluating the diversity of recommended content.

FIG. 7 illustrates an example component architecture for a topic-controllable personalized recommendation system.

FIG. 8A illustrates an example interest space spanned by the taxonomy topics.

FIG. 8B illustrates an example scheme for using weights of different topics to sample topics for particular users.

FIG. 9 illustrates an example topic-content graph showing corresponding relationship and weights.

FIG. 10 illustrates an example system architecture and workflow.

FIG. 11 illustrates an example method of generating personalized content recommendations for users.

FIG. 12A illustrates an example network environment associated with a social-networking system.

FIG. 12B illustrates an example network environment associated with a social-networking system

FIG. 13 illustrates example social graph.

FIG. 14 illustrates an example computer system.

### DESCRIPTION OF EXAMPLE EMBODIMENTS

An advertiser can target advertisements to interested consumers within a social network. Advertisers may effectively target consumers even when personal information or preferences of users is unavailable. Access to user information or preferences are often limited or unavailable when an online content provider is privacy focused, such as in a privacy focused social network. To implement a reverse advertisement targeting technique, advertisers make their advertisements available for viewing and users select the types of advertisements they wish to view. To incentivize users to view preferred advertisements, users earn credit for viewing advertisements. Users may use the credit to get some sort of benefit from the advertised service. Users may like or dislike viewed advertisements, and this will affect the advertisements that will appear on the users' queue.

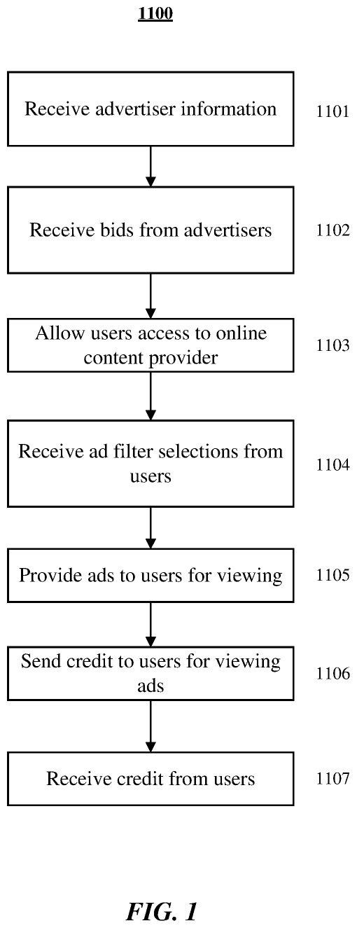

FIG. 1 illustrates an example method 1100 for reverse advertisement targeting within a social network. The method may begin at step 1101 where advertisers and businesses provide business information and details relating to their advertisements. This information is required for users to utilize filter options in step 1104. In a particular embodiment, some or all of the business information can be obtained and or sorted using classifiers trained by known machine learning methods.

At step 1102, advertisers may bid to make their advertisements viewable to users. Advertisers may specify a price they are willing to bid per advertisement per view. In a particular embodiment, advertisers may be required to bid a minimum price to make their advertisements available to users for viewing. In another embodiment, the higher an advertiser's bid is relative to other advertisers, the more likely or often the advertiser's ads will be displayed to users. Alternatively, the ads of higher bidders may be listed at a higher priority level compared to other advertisers or may be displayed in a more prominent position or manner. In a particular embodiment, the amount bid by advertisers will influence the amount of credit a user will receive for viewing the ad. For example, and not by way of limitation, if an advertiser bid $1100 to display their ad, the user may receive 1 credit for viewing the ad. But, if the user watched a different ad where the advertiser bid $1200, the user may receive 2 credits. In a particular embodiment, the advertiser's bid value will influence the amount of credit a user will receive for watching, and the user will be informed of how many credits he or she will receive before viewing the ad. Users may choose to filter advertisements based on the amount of credit they will receive for watching the ad at step 1104.

At step 1103, a user accesses an online platform, such as a content provider. The online platform may be any type of service provider which provides the platform for viewing advertisements. In a particular embodiment, a content provider may include but is not limited to, an online social network, a video streaming and viewing site, an email service, or any other online platform that provides a service. In a particular embodiment, the content provider may be a privacy focused service provider such as a privacy focused social network where none of the information about users is stored or exposed to advertisers for advertisement targeting. User identification may be the only information stored on the privacy focused social network.

At step 1104, a user may filter types of advertisements he or she wishes to view while accessing a content provider's online platform. Users may specify different filters, such as but not limited to, category of business, location, language, scale, popularity, type of product, and new or established business. The business information used in the filtering step may be provided by advertisers and businesses in step 1101. Also, in a particular embodiment, credit amount could be a filter and the user may filter based on the credit information provided to the user at step 1102. For example, and not by way of limitation, the user may filter only for ads that will provide over a specified amount of credits for viewing. Alternatively, the user could choose not to filter based on credits and filter based on other types of information instead, such as but not limited to product or service type, or business information. In a particular embodiment, filtering ads by users may be an optional step. In another embodiment, a user's ad preferences may be filtered automatically based on the information learned from the user's actions after viewing an ad. The user's actions after viewing an ad are further described at step 1105 and may include but are not limited to liking or disliking a particular advertisement after viewing.

At step 1105, an advertisement is provided to a user for viewing. In a particular embodiment, a user may provide some sort of feedback after viewing the ad. For example, if the user was not interested in the advertisement, the user may flag or dislike the advertisement and appropriate filters are adjusted to reflect the lack of interest. If the user was interested in the advertisement, the user may like it and similar kinds of advertisements will be prioritized in their advertisement play queue. In an embodiment, the credit information from step 1102 may be displayed to the user. The user may then provide feedback for the viewed ad based solely or in part on the amount of credit received for viewing. For example and not by way of limitation, the user may like an ad just because the ad provided a large amount of credit for viewing. In a particular embodiment, the user's feedback after viewing an ad may be used to automatically filter ads based on the user's indicated preferences. For example and not by way of limitation, if the user repeatedly likes advertisements for automobiles, filters may automatically filter more ads for automobiles to be shown to the user. In another embodiment, filters may automatically filter for ads that provide at least a specific amount of credits for viewing. Furthermore, the user may also forward advertisements to friends that may be interested. The sent advertisements will be added to their friends' advertisement queue. The friends will earn credit for viewing the ad and may also provide their own feedback.

At step 1106, users may earn credit for viewing advertisements. The amount of credit earned for viewing an advertisement may be proportional to the advertisement price paid by the advertiser in step 1102. At step 1107, users may use credit to receive some sort of benefit from the advertised service or product, or from the online content provider itself. For example, but not by way of limitation, users may apply credits to use the advertised service for free of cost for a certain amount of time proportional to the value of credits applied. Alternatively, the user may receive a discounted price when purchasing the advertised good or service proportional to the value of credits applied, or some other benefit. Furthermore, the user may apply credit towards benefits from the online content provider itself. For example and not by way of limitation, if the content provider which hosted the advertisement provided an online music streaming service, the credit may be applied to access the music streaming service.

Embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for reverse advertisement targeting within a social network including the particular steps of the method of FIG. 1, this disclosure contemplates any suitable method for reverse advertisement targeting within a social network including any suitable steps, which may include all, some, or none of the steps of the method of FIG. 1, where appropriate.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social network. A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example, and not by way of limitation, advertisements may be included among the search results of a search-results page, where sponsored content is promoted over non-sponsored content.

In particular embodiments, an advertisement may be requested for display within social network webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social network may execute or modify a particular action of the user.

An advertisement may also include social network functionality that a user may interact with. As an example, and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user of the social network or RSVP to an event associated with the advertisement. In addition or as an alternative, an advertisement may include social network content directed to the user. As an example and not by way of limitation, an advertisement may display information about a friend of the user within social network who has taken an action associated with the subject matter of the advertisement.

As users consume and engage with increasing volumes of content, finding a particular piece of desired content may be difficult. For example, locating a given tab in a browser with many open tabs or a given discussion in a list of chat threads may be frequent problems for some users. It may be possible for a user to manually group or organize this content; however, such a manual process may be tedious and time-consuming, particularly as it may need to be repeated often. The user may need to manually reorder and create groups of tabs, move tabs between groups, sort new tabs into groups, tag the tabs, and perform similar reordering and tagging of chat threads. Automating such reordering of content may thus minimize the need for extensive user input. This automation may be based on the use of machine-learning models to infer or replace intended user behavior, and these models may be highly user-specific.

In particular embodiments, with regards to browser tabs, grouping information associated with a plurality of first tabs grouped by a first user may be determined. Such grouping of the tabs may be based on the content of the tabs, user behavior, and/or timing information. Thus, contents of the plurality of first tabs and interaction contexts in which the first user interacts with the plurality of first tabs may be determined. Content of the tabs may be determined based on semantic analysis of each tab. As examples, such analysis may be based on natural language processing (NLP) techniques, media content analysis, or knowledge coming from authoritative sources (e.g. domain techcrunch.com may be classified as news, walmart.com may be classified as e-commerce, etc.). User behavior may be based on determining various ways that the user interacts with different tabs. As examples, timestamps (at what time the user interacts with the tabs) or knowledge of the user context (e.g. they have a block “work on feature X” in their calendars) may be determined. Such user interactions may further provide additional context of the user behavior (e.g., work-related vs. personal activity). Timing information of the creation of the tabs themselves may also be determined. For example, tabs opened in sequence or within a certain amount of time may be more likely to belong to a same group (e.g., an online shoe shopping session in which multiple potential purchases are each opened in a separate tab).

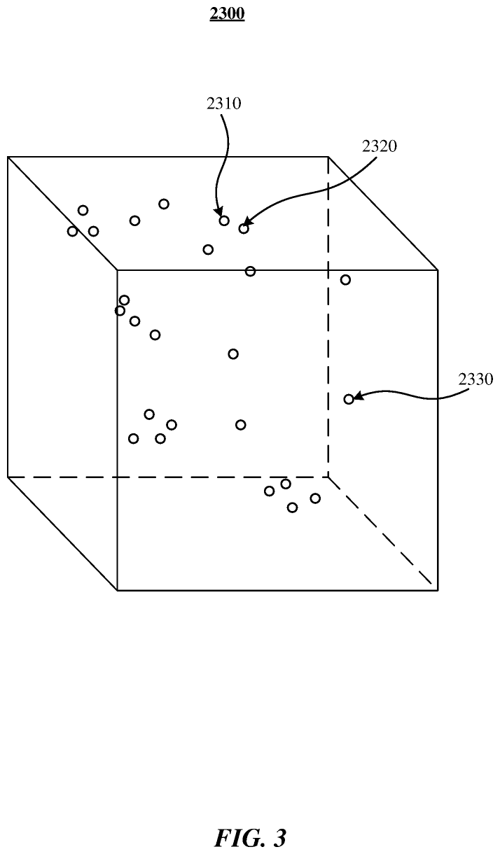

In particular embodiments, using these families of features (i.e., content-based and user behavior features), a machine-learning model to group the tabs may be generated. For example, using the grouping information, the contents, and the interaction contexts associated with the plurality of first tabs, a machine-learning model may be trained to process content and interaction context associated with a tab to generate an embedding in a d-dimensional embedding space to represent the tab. These embeddings may then be clustered in the d-dimensional embedding space. As an example, one such clustering technique may include thresholding on max intra-cluster distance. Generation of such embeddings and similarity metrics is discussed in more detail below with respect to FIG. 3. Similarity metrics may be highly individualized so that embeddings and clusters are specific to a particular user engaging with the content, thus minimizing the amount of user interaction or correction when grouping the tabs. As examples, similarity metrics may be based on tabs that have been manually grouped together by the user in the past. These tabs should be clustered close together in the embedding space. Such clustering may be based on various techniques; as one example, triplet loss may be used. Here, positive pairs may be generated by looking at sets of tabs that have been manually put together by the user.

The resulting machine-learning model may be highly personalized, since different users may want to group tabs differently. Thus, the model may be continuously refined as the user continues to interact with the content. Signals such as “the user manually groups tabs” or “the user breaks a group of tabs created by the model” or “the user removes a specific tab from an automatically created group” may be used for such personalization and heavily weighted. Such values may be considered “hard negatives” in a triple loss setting.

In particular embodiments, once the machine-learning model has been created, an embedding in the d-dimensional embedding space using the trained machine-learning model may be generated for each of a plurality of second tabs. The plurality of second tabs may then be grouped based on the determined embeddings of the plurality of second tabs. As an example, if a user has thirty tabs open in a browser window, the content of each tab may be determined. For instance, such content analysis may determine that tabs 1-4 and 12-17 are news articles, that tabs 5, 18, 20-25, and 29-30 are shopping sites, etc. User interaction with these tabs may also be determined. As an example, shopping tabs 5, 18, and 20-25 may have all been opened within a given time period (e.g., one hour) and may all deal with electronics. By contrast, tabs 29 and 30 may also be shopping sites, but may be determined to be clothes shopping sites. It may further be determined that some tabs (e.g., tabs 6-11) were opened during working hours, or involve topics related to the user's job.

Then, using this determined information, the tabs may be reordered. For example, tabs 1-4 and 12-17 may be grouped together so that they appear as tabs 1-10 in the browser window. In particular embodiments, this grouping of tabs may be separated from other tabs by, for example, a spacer. In some embodiments, this grouping may be given a header of “News” displayed as the title of a super tab, under which the individual tabs 1-4 and 12-17 are clustered. These tabs may be visible, or they may be condensed so that they appear after the “News” super tab is selected. In further embodiments, tab groupings may even be nested. For example, the electronics and clothes shopping tabs may be grouped under a super tab of “Shopping”, with tabs 5, 18, and 20-25 grouped under a sub-super tab titled “Electronics” and tabs 29-30 grouped under a sub-super tab titled “Clothing”. Finally, as new tabs are opened, they may be sorted to particular super tabs as appropriate based on the machine-learning model.

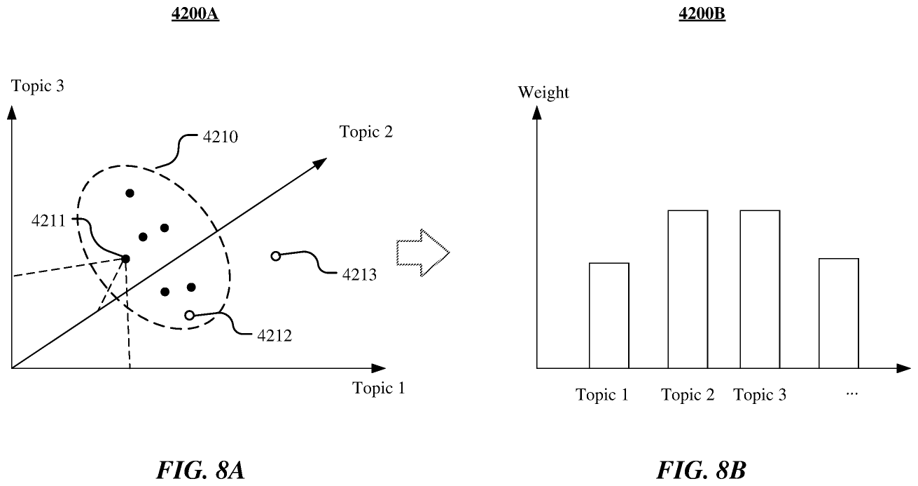

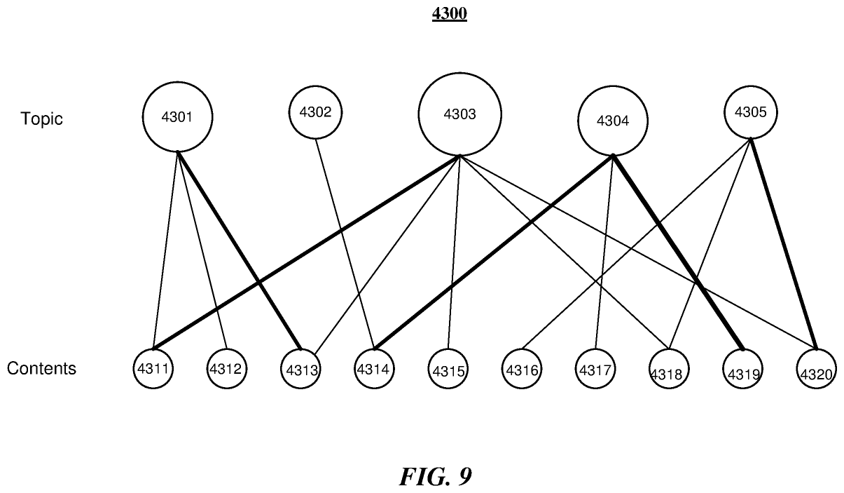

In a similar manner, chat threads may also be grouped or reordered based on content and/or user interactions with various discussions. As an example, content analysis of chat threads may also include determining features such as like social relationships between the user and people they are interacting with, or between the user and a person who shared a link that the user has opened. In particular embodiments, subject to privacy settings, such social information may be determined based on social-networking data, as discussed below with respect to FIGS. 8A and 8B. Based on the content and/or user behavior information, chat threads, such as those in messaging apps, may be grouped into groups such as “Family discussions”, “Discussions with friends”, “Work discussions”, or other custom groups. Such grouping for messaging apps may thus allow the user to find a particular discussion more easily. For instance, rather than scrolling through dozens or even hundreds of discussions, the user may be able to go to the “Family discussions” group and then search in a much smaller pool of chats for a desired target chat.

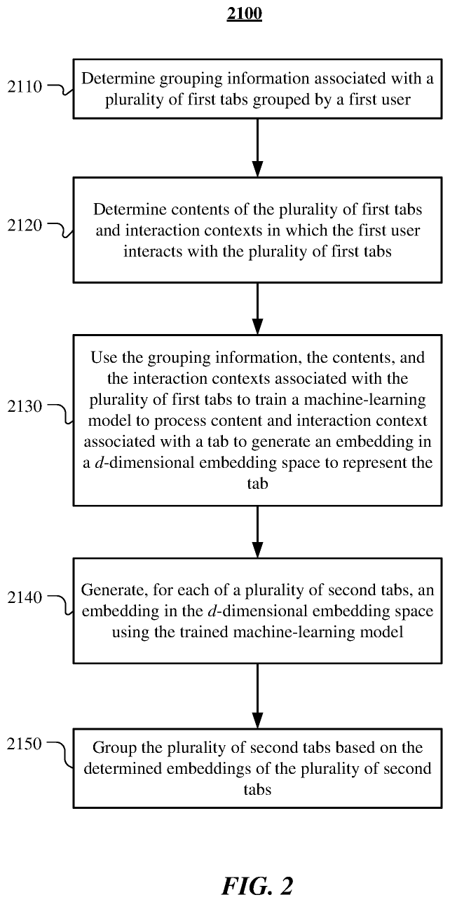

FIG. 2 illustrates an example method 2100 for grouping a plurality of tabs based on content of the tabs and interaction contexts of a user with the tabs. The method may begin at step 2110, where the method may determine grouping information associated with a plurality of first tabs grouped by a first user. At step 2120, contents of the plurality of first tabs and interaction contexts in which the first user interacts with the plurality of first tabs may be determined. At step 2130, using the grouping information, the contents, and the interaction contexts associated with the plurality of first tabs, a machine-learning model may be trained to process content and interaction context associated with a tab to generate an embedding in a d-dimensional embedding space to represent the tab. At step 2140, the method may generate, for each of a plurality of second tabs, an embedding in the d-dimensional embedding space using the trained machine-learning model. Finally, at step 2150, the plurality of second tabs may be grouped based on the determined embeddings of the plurality of second tabs. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for grouping a plurality of tabs including the particular steps of the method of FIG. 2, this disclosure contemplates any suitable method for grouping a plurality of tabs including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

FIG. 3 illustrates an example view of a vector space 2300. In particular embodiments, an object or an n-gram may be represented in a d-dimensional vector space, where d denotes any suitable number of dimensions. Although the vector space 2300 is illustrated as a three-dimensional space, this is for illustrative purposes only, as the vector space 2300 may be of any suitable dimension. In particular embodiments, an n-gram may be represented in the vector space 2300 as a vector referred to as a term embedding. Each vector may comprise coordinates corresponding to a particular point in the vector space 2300 (i.e., the terminal point of the vector). As an example and not by way of limitation, vectors 2310, 2320, and 2330 may be represented as points in the vector space 2300, as illustrated in FIG. 3. An n-gram may be mapped to a respective vector representation. As an example and not by way of limitation, n-grams t₁ and t₂ may be mapped to vectors [symbol] and [symbol] in the vector space 2300, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 2300. In particular embodiments, an n-gram may be mapped to a vector representation in the vector space 2300 by using a machine leaning model (e.g., a neural network). The machine learning model may have been trained using a sequence of training data (e.g., a corpus of objects each comprising n-grams).

In particular embodiments, an object may be represented in the vector space 2300 as a vector referred to as a feature vector or an object embedding. As an example and not by way of limitation, objects e₁ and e₂ may be mapped to vectors [symbol] and [symbol] in the vector space 2300, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 2160 may calculate a similarity metric of vectors in vector space 2300. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 2300. As an example and not by way of limitation, vector 2310 and vector 2320 may correspond to objects that are more similar to one another than the objects corresponding to vector 2310 and vector 2330, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

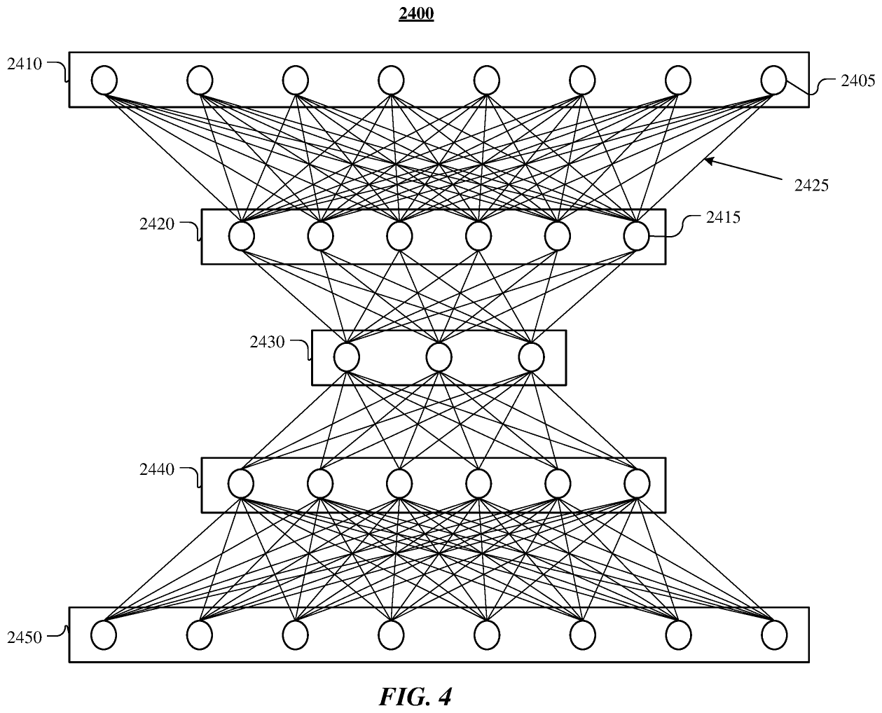

FIG. 4 illustrates an example artificial neural network (“ANN”) 2400. In particular embodiments, an ANN may refer to a computational model comprising one or more nodes. Example ANN 2400 may comprise an input layer 2410, hidden layers 2420, 2430, 2440, and an output layer 2450. Each layer of the ANN 2400 may comprise one or more nodes, such as a node 2405 or a node 2415. In particular embodiments, each node of an ANN may be connected to another node of the ANN. As an example and not by way of limitation, each node of the input layer 2410 may be connected to one of more nodes of the hidden layer 2420. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 4 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 4 depicts a connection between each node of the input layer 2410 and each node of the hidden layer 2420, one or more nodes of the input layer 2410 may not be connected to one or more nodes of the hidden layer 2420.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 2420 may comprise the output of one or more nodes of the input layer 2410. As another example and not by way of limitation, the input to each node of the output layer 2450 may comprise the output of one or more nodes of the hidden layer 2440. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(Sₖ)=max(0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 2425 between the node 2405 and the node 2415 may have a weighting coefficient of 0.4, which may indicate that 0.4 multiplied by the output of the node 2405 is used as an input to the node 2415. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 2400 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

As users consume and engage with increasing volumes of content, presenting relevant recommendations in an engaging manner may be difficult. Studies have shown that if recommended content is too diverse, user engagement with that content decreases, but user engagement also decreases if the content is too similar. Many different algorithms and considerations may be used to determine content to recommend to a user and to diversify this recommended content, with varying degrees of success, particularly as many of these algorithms are constantly updated over time to reflect an increasing amount of user data. Levels of diversity of recommended content may be measured, as well as their effects on success metrics such as user engagement.

When presenting recommendations of media items to a user, recommender systems often recommend content that is either too diverse or too similar. In particular embodiments, in cases where recommended content is based on a particular piece of content the user has recently viewed, recommended media items that are too similar to that particular content may fail to attract the user's interest. As an example, the user may have viewed or liked an image of a dog wearing a hat, only to find that a great number of subsequent recommended media items display dogs wearing hats. Such over-similarity of recommended content may be especially noticeable in applications where a view having a set of media items is displayed on the screen of the user's device. In this case, most or all of the media items of the view displayed on the screen at once may be just this similar content. The user may thus only briefly interact with some of the media items, or may simply scroll past the similar media items until they find new content or leave altogether.

Lack of content diversity in the recommended media items of a view may lead to poor user perception content quality. Further, studies have shown that user engagement with recommended content decreases both when the content is too diverse (for example, due to lack of relevance) as well as when the content is too similar (for example, due to boredom). The average time spent by a user per unique media item (such as a video clip) was closely related to the maximum similarity of the clip with all of the user's other video clips. If the most similar media item was overly dissimilar to the closest other media item of a given view, the user spent less time watching it. This may have been a reflection of the clip not being relevant enough to the user. On the other hand, if the most similar clip was too similar to the next most similar clip, the user also spent less time watching it, possibly because it was not distinct enough. However, it has often been believed that increasing diversity could hurt goal metrics (such as the time spent watching a given clip) in the short-term and that a trade-off needed to be made, and that even if a concept like diversity could be measured, it would be too abstract to be interpretable, let alone actionable.

Similarity of media items may be determined using embeddings in a d-dimensional vector space, as illustrated in FIG. 3. There are many ways in which content such as media items may be diverse. In particular embodiments, diversity of media items may be defined at the user level, dealing with diversity and similarity of media items within a given view over a given time period (for example, a day, or a particular viewing session). Diversity considerations may involve author diversity (for example, ensuring that not too many recommended media items are from the same author), audio diversity (for example, ensuring that not too many recommended media items feature a same trending song), topic diversity (for example, ensuring that, if a user liked a video of a dog, not too many recommended media items are of dogs), diversity of types of authors, popularity diversity (for example, ensuring that media items from both large, popular accounts and smaller ones are recommended), or sentiment diversity (for example, recommending media items that are funny, surprising, educational, etc.). An optimum diversity range of these metrics may be measured in various success metrics. As examples, for video clips, diversity may be indicated by the average time spent by a user per unique video clip, the average percent of a clip viewed, the average fraction of clips that the user liked, the average fraction of clips where the user instructed the app to “see less” clips like this, the average fraction of clips where the user viewed the profile of the author, or the average fraction of clips where the user followed the author.

Another important metric may be visual diversity (e.g., ensuring that not too many recommended media items, such as video clips, look the same). As an example, recommended clips in a view should not all show only dancing people, lip synching videos, or a same video reposted by multiple accounts. Visual diversity may be measured by XRay embedding distances. XRay is an embedding space, similar to vector space 2300, based on image features of several frames of a video clip, as well as labeled categories (for example, “baseball”). Videos that look similar are close together, and videos that are different are far apart. Taking the example of visual diversity, similarity of media items relative to one another may be determined using a metric on a user-item level rather than on a broader user level. This may ensure that diversity is measured not just item by item, but with respect to the entire view. It may further ensure that diversity is user-specific, measuring the diversity not just of which media items are identified as similar to a particular piece of content, but of a particular user's entire view of media items. Thus, the relative diversity that a given media item, such as a video clip, offers to an entire particular view, rather than just its similarity to its nearest neighbor, may be assessed.

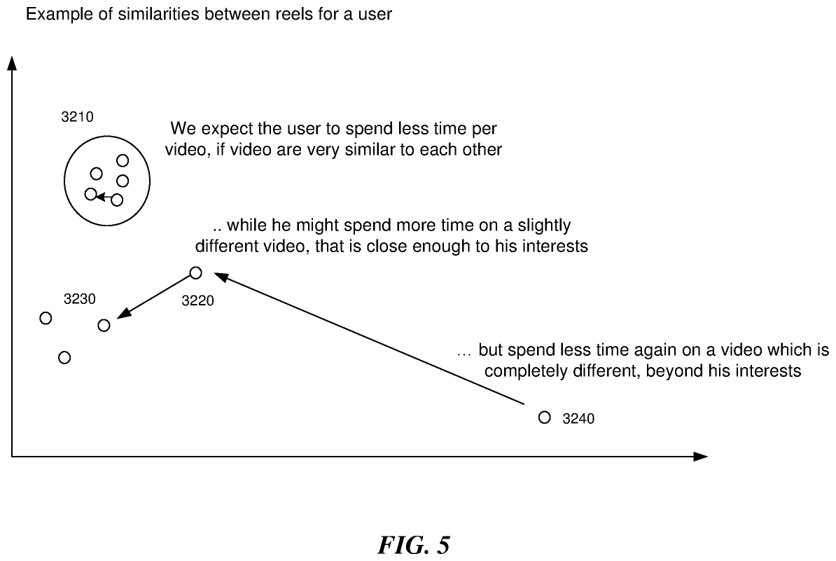

FIG. 5 illustrates an example of similarities between media items for a given user. As illustrated, it may be desirable to provide the user with visual diversity within a specific topic (for example, baseball or sandwiches). Here, a conceptual illustration of a simplified embedding space similar to vector space 2300 described in FIG. 3 considers a given user, view, and time window (for example, one day). In particular embodiments, a set of recommended media items for display to a first user using a plurality of views may be determined based on a recommendation ruleset. Such a recommendation ruleset may be, for example, a machine-learning algorithm, such as those discussed with respect to FIG. 4. Each view of the plurality of views may be configured to display a subset of recommended media items in the set (for example, twenty media items per view). A cluster 3210 of similar recommended media items may be initially determined. Media items within this cluster 3210 may be visually very similar. As an example, the set of recommended media items may be based on a video clip the first user recently viewed, of a dog wearing a hat while performing tricks. Media items in the cluster 3210 may also feature dogs performing tricks while wearing hats. Meanwhile, media item 3220 may show a slightly different video of a cat performing tricks while wearing a hat. And media items 3230 may be clips of various animals performing a given trick. Media item 3240, by contrast, may be a video clip of a person wearing a hat at a baseball game.

In particular embodiments, for each of the plurality of views, a pair of media items in the subset of recommended media items associated with the view may be identified, the identified pair of media items having a highest similarity score among pairs of media items in the subset. Often, a metric that determines an average intra-list distance (i.e., the average distance between each pair of media items) has been used to measure diversity. A commonly used equation for such an average intra-list distance may be:

$$ILD = \frac{1}{\vert R \vert ( \vert R \vert - 1 )} {\sum }_{i ∈ R} {\sum }_{j ∈ R} d ( i , j )$$

However, this metric is coarse, and often only roughly captures some degree of relevance. And when XRay embeddings are used for capturing a degree of visual similarity, the average cosine similarity over all pairs of media items may be used as a metric for similarity. However, this metric may often may not capture cases in which there are some similar media items in an otherwise diverse population.

Accordingly, rather than computing the average similarity for the first user across all his media items, the maximum similarity (i.e., the smallest distance) for each user-media item pair (i.e., for each view) may be computed. For each media item in a particular view, the distance may be computed to the closest other media item. Simultaneously, for a single clip, the average distance to all other clips may be indicative of its overall relevance. Thus, relevant content, that is still acceptably diverse, may be determined for each view over a plurality of views. Research showed that the expected trade-off between diversity and short-term metric goals did not exist, and that more diverse content that was still relevant actually drove more user engagement. Thus, a second metric scoring whether a pair of media items was “too similar” may be used as an interpretable and actionable metric to optimize a recommender system. Such a similarity score metric may range from 0 to 1, where “1” indicates identical media items. In one example, a threshold of 0.8 may indicate that two media items are “very similar”, while a threshold of 0.6 may indicate that this pair of items is “somewhat similar”.

The pair of media items in the set of recommended media items having this maximum similarity may thus be a good indicator of an overall visual diversity of an entire view of media items. Accordingly, in particular embodiments, visual-diversity scores for the plurality of views based on the highest similarity scores associated with the identified pairs of media items associated with the plurality of views may be generated based on a visual-diversity ruleset. These visual-diversity scores may in turn be used to adapt the recommender system, for example, by updating the recommendation ruleset, for promotion of more optimized diversity in future media item recommendations and presentation. Additionally, the visual-diversity scores may be used at run-time, to update the recommendation ruleset and populate each successive view as the first user scrolls through them. In machine-learning embodiments, updating the recommendation ruleset may include updating various weights of a given algorithm. In particular embodiments, if the similarity score of the identified pair of media items is too high, the visual-diversity score for its corresponding view may be decreased. This decreased score may be provided to developers, who may then determine how well a given diversity algorithm is working.

Based on the visual-diversity scores of one or more of the views, the developers may update or change a given diversity algorithm. In particular embodiments, to measure whether these changes actually improve the diversity of the recommended media items, a second layer of prevalence metrics may be used. An operational metric may determine the prevalence of content that is too similar in a particular view. Ensuring that a given view does not have too many media items that fall above, for example, the 0.6 threshold of “somewhat similar” may provide the user with diversity, but within a given topic. This increase in relevant diversity may in turn increase user engagement. For example, for videos, studies have found that simply showing five or more media items per page of content that is “too/very similar” can reduce the watch time per clip by around four seconds. Thus, reducing the number of “very similar” media items may increase user engagement. However, depending on particular diversity goals, even reducing the number of “somewhat similar” media items may increase user engagement in certain circumstances.

In particular embodiments, if this operational metric indicates that too many media items in a view are “too similar”, various actions to reduce this content and promote diversity may be taken. As one example, particular algorithms that are increasing the number of too similar media items may be identified and updated or changed. For instance, item-based kNN models may actually decrease diversity in certain situations. As another example, a number of random media items may be removed or replaced.

Yet another way to promote diversity of relevant recommended content may involve ensuring that relevant but similar content is spread out over multiple views, so that no single view presents a set of media items that are overly similar to one another. As an example, a single view may present twenty media items to a user, and the user may then scroll to a next view with twenty more media items after seeing the first view. If fifteen pictures of dogs with hats are selected to be recommended to the user, these fifteen media items may be spread out among a hundred media items, so that each twenty-media item view provided to the user includes only a few of those fifteen pictures. Similarly, diversity of content may be promoted by limiting the number of very similar media items recommended. As an example, when selecting the subset of recommended media items from a set including media clusters 3210-3240, only one or two media items from cluster 3210 may be selected and presented to the first user, rather than selecting most or all of these clustered media items.

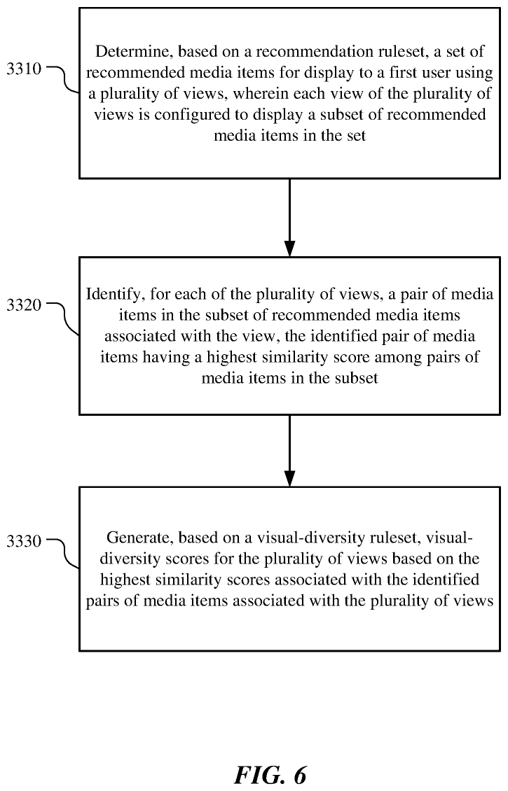

FIG. 6 illustrates an example method 3300 for evaluating the diversity of recommended content. The method may begin at step 3310, where, based on a recommendation ruleset, a set of recommended media items for display to a first user using a plurality of views may be determined, wherein each view of the plurality of views is configured to display a subset of recommended media items in the set. At step 3320, for each of the plurality of views, a pair of media items in the subset of recommended media items associated with the view may be identified, the identified pair of media items having a highest similarity score among pairs of media items in the subset. Finally, at step 3330, based on a visual-diversity ruleset, visual-diversity scores for the plurality of views based on the highest similarity scores associated with the identified pairs of media items associated with the plurality of views may be generated. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for evaluating the diversity of recommended content including the particular steps of the method of FIG. 6, this disclosure contemplates any suitable method for evaluating the diversity of recommended content including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

In particular embodiments, social-networking system 4660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 4670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 4660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 4660 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 3100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 4660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 4660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 4660 may calculate a coefficient based on a user's actions. Social-networking system 4660 may monitor such actions on the online social network, on a third-party system 4670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 4660 may calculate a coefficient based on the user's actions with particular types of content. The content may be associated with the online social network, a third-party system 4670, or another suitable system. The content may include users, profile pages, posts, news stories, headlines, instant messages, chat room conversations, emails, advertisements, pictures, video, music, other suitable objects, or any combination thereof. Social-networking system 4660 may analyze a user's actions to determine whether one or more of the actions indicate an affinity for subject matter, content, other users, and so forth. As an example and not by way of limitation, if a user frequently posts content related to “coffee” or variants thereof, social-networking system 4660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 4660 may calculate a coefficient based on the type of relationship between particular objects. Referencing the social graph 4700, social-networking system 4660 may analyze the number and/or type of edges 4706 connecting particular user nodes 4702 and concept nodes 4704 when calculating a coefficient. As an example and not by way of limitation, user nodes 4702 that are connected by a spouse-type edge (representing that the two users are married) may be assigned a higher coefficient than a user nodes 4702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 4660 may determine that the user has a higher coefficient with respect to the first photo than the second photo because having a tagged-in-type relationship with content may be assigned a higher weight and/or rating than having a like-type relationship with content. In particular embodiments, social-networking system 4660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 4660 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 4700. As an example and not by way of limitation, social-graph entities that are closer in the social graph 4700 (i.e., fewer degrees of separation) may have a higher coefficient than entities that are further apart in the social graph 4700.

In particular embodiments, social-networking system 4660 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 3430 of the user). A first user may be more interested in other users or concepts that are closer to the first user. As an example and not by way of limitation, if a user is one mile from an airport and two miles from a gas station, social-networking system 4660 may determine that the user has a higher coefficient for the airport than the gas station based on the proximity of the airport to the user.

In particular embodiments, social-networking system 4660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 4660 may provide information that is relevant to user's interests and current circumstances, increasing the likelihood that they will find such information of interest. In particular embodiments, social-networking system 4660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 4660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 4660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 4670 (e.g., via an API or other communication channel), or from another suitable system. In response to the request, social-networking system 4660 may calculate the coefficient (or access the coefficient information if it has previously been calculated and stored). In particular embodiments, social-networking system 4660 may measure an affinity with respect to a particular process. Different processes (both internal and external to the online social network) may request a coefficient for a particular object or set of objects. Social-networking system 4660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 3504 corresponding to a particular photo may have a privacy setting specifying that the photo may only be accessed by users tagged in the photo and their friends. In particular embodiments, privacy settings may allow users to opt in or opt out of having their actions logged by social-networking system 4660 or shared with other systems (e.g., third-party system 4670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 4670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 3462 may be authorization/privacy servers for enforcing privacy settings. In response to a request from a user (or other entity) for a particular object stored in a data store 3464, social-networking system 4660 may send a request to the data store 3464 for the object. The request may identify the user associated with the request and may only be sent to the user (or a client system 3430 of the user) if the authorization server determines that the user is authorized to access the object based on the privacy settings associated with the object. If the requesting user is not authorized to access the object, the authorization server may prevent the requested object from being retrieved from the data store 3464, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Internet may be the biggest information platform worldwide. From various sources and channels, people can read news articles, upload travel notes, share photos, and watch short-form videos. Many applications (referred to as “apps”) supporting those rich contents emerge on internet, such as, social media platforms, search engines, news feeds, podcasts, online news websites, blogs, etc. Some apps have become the de facto standard apps of our daily life. Recommendation may have been utilized in those systems, but also faces many fundamental challenges. Personalized recommendation may refer to finding contents most relevant to a user's interest. Generally speaking, personalized recommendation may include a process of gathering information about engagement behaviors, analyzing interests/preference, predicting interest and preference, and delivering the relevant content to users accordingly. User control in personalized recommendation may allow users to steer and have control over the recommendation process, for example, by providing ratings, editing user data, and adjusting weights of the algorithm. Topic control may be an important feature of user control, where users can specify what they want to see or not in an interpretable way, and therefore influences the recommendation process.

Massive dynamic content may make topic control challenging for personalized recommendation in terms of both algorithm complexity and system efficiency. First, personalization may require customized recommendations for each user. Since social media and search over may have massive active users, the personalization workload may be huge. Second, a large number of content venders may produce a large amount of new contents every day. But many videos may only remain active within a dozen days. Recommending a set of videos to each user from such a huge and dynamic video pool may be a challenging task. In particular embodiments, to solve these problems, the system may use an innovative design of a topic-controllable personalized recommendation system on massive dynamic contents.

In this disclosure, particular embodiments of the system may be a personalized recommendation system on massive dynamic contents that supports topic control. As a recommendation system, the input and output of the functionality of the system may include a user ID as an input and a set of contents as outputs. In practice, before the user to content recommendation can be made, in the preprocessing or data preparation, the input to the system may also include to understand users' interest or preference including, for example, users' engagement log with the contents, taxonomy (or a set of taxonomies) to provide topics, content labeling service to associate a content with a set of topics, the metadata such as the content popularity, etc. In particular embodiments, the recommendation system may fulfill a number of requirements including, for example, personalization, topic control, large scale recommendation, dynamic update, etc. For the personalization, the system may keep the recommendation result relevant to each user' personal taste or preferences, rather than treating all users in the same approach. A reasonable personalization may consider both the similarity to a user's historic engagement and the diversity of recommendation. For the topic control, the system may provide control to the user agency, so that users (i.e. viewers) can decide what to see or not to see by specifying the topics. For example, a user may specify that the favorable topics include “sports”, “cartoon”, and “dancing,” etc. The user may specify the topics to exclude particular topics that the user prefers not to view. For the large scale recommendation, the recommendation algorithm may have reasonably low complexity to handle recommendations for a large number of users (e.g., up to billions of users) with a large number of contents (e.g. news articles, short videos, etc.). For the dynamic update, the system may be sufficiently efficient to update the active content pool during recommendation, since content consumers usually have short attention.

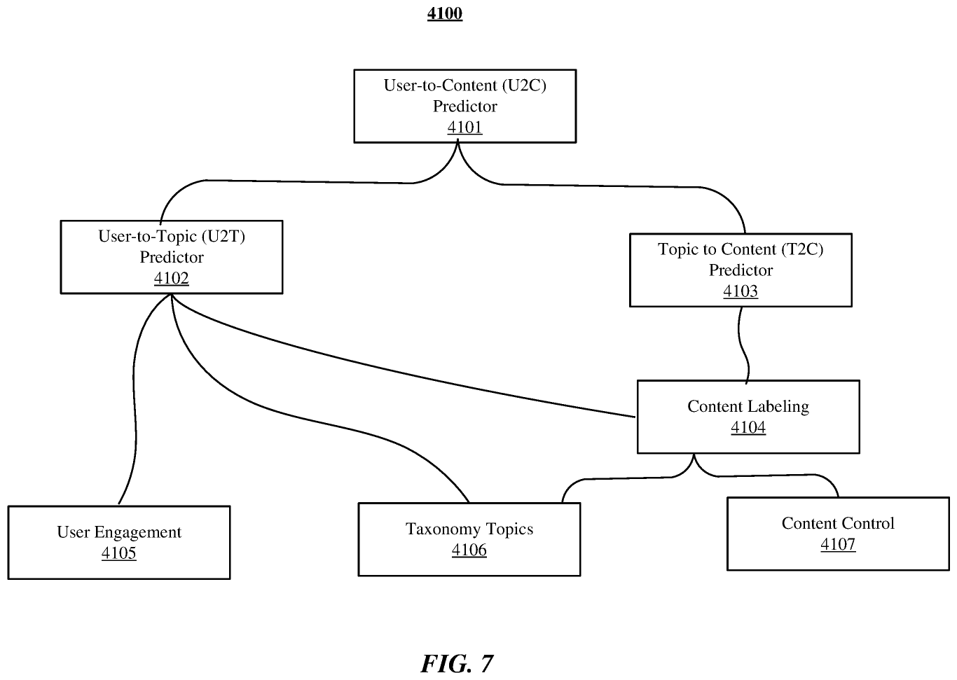

FIG. 7 illustrates an example component architecture 4100 for a topic-controllable personalized recommendation system. In particular embodiments, the system may solve the topic-controllable personalized recommendation problem using the component architecture as illustrated in FIG. 7. In particular embodiments, the system may include a user-to-content (U2C) predictor 4101, a user-to-topic (U2T) predictor 4102, a topic-to-content predictor 4103, etc. In particular embodiments, the goal of a content recommendation, as described in the problem statement, may be to identify a subset of contents for a given user, which may be referred to as the user-to-content predictor (U2C), as shown in the top block in the diagram as illustrated in FIG. 7. The functionality may be decomposed into two components including, for example, the user-to-topic (U2T) predictor 4102 and the topic-to-content (T2C) predictor 4103. For the user-to-topic (U2T) predictor, the system may use a user modeling component to represent a user's interest or preference in a topic space spanned by the topics specified in the given taxonomy. More specifically, for a given user, the U2T predictor 4102 may take two inputs including, for example, the user's recent activity history from the user engagement component 4105 such as the recently watched videos, and the taxonomy topics 4106 that describe the content semantics/emotions such as sports, landscape, funny, lovely, etc. The U2T predictor 4102 may also have the input from the content labeling component 4104. The content labeling component 4104 may have two inputs including the taxonomy topics 4106 and the content control 4107 (e.g., as specified by user inputs) and may generate the labelled contents as outputs. The outputs of the content labeling component 4104 may be fed to both the U2T predictor 4102 and the T2C predictor 4103. Then, the outputs of the U2T predictor 4102 and the T2C predictor 4103 may be fed into the U2C predictor 4101, which may output a set of recommended content for particular users.

FIG. 8A illustrates an example interest space 4200A spanned by the taxonomy topics. In particular embodiments, each axis of the interest space may be a topic (e.g., topics 1-3). The measurement may be the strength of a content belonging to that topic (or in other words, a degree of relevance between a content and the topic of each axis). For a given user, each recently engaged content may correspond to a dot in the space (e.g., 4211), where the dot's location (i.e. coordinates) may be determined by the content labeling component as shown in FIG. 7. Details will be discussed in later sections when introducing the content labeling component. Given such a distribution of engaged contents of a given user, the system can predict if a newly uploaded content would fall into the interest of the user, according to the topics of the new content and its likelihood with respect to the distribution. For example, the system may determine that for a particular user, a personalized interest distribution 4210 in the interest space 4200A including a number of contents (e.g., 4211) that are related to that particular user. For a new content 4212, the system may determine its location in the interest space by determining its coordinates based on the corresponding degree of relevance to other contents and the interest distribution 4210. Because the new content 4212 falls within the boundary of the personalized interest distribution 4210, the system may predict that the user would likely be interested in the new content 4212. As another example, for a new content 4213, the system may determine its location in the interest space by determining its coordinates based on the corresponding degree of relevance to other contents and each topic of the interest space and the interest distribution 4210. Because the new content 4212 falls outside the boundary of the personalized interest distribution 4210, the system may predict that the user would likely be not interested in the new content 4212. It is notable that, even though FIG. 8A illustrates an interest space with three dimensions corresponding to three topics, the interest space is not limited to three dimensions. For example, the interest space may have any suitable number of dimensions and any suitable number of topics. The system may determine the interest distributions for users. Each interest distribution may be associated with a number of topics defining the related interest space. At run time, the system may use these interest distributions and the corresponding interest space to predict interested topics for users. Also, the predicted interest topics may be determined based on the engagement data of the users.

FIG. 8B illustrates an example scheme 4200B for using weights of different topics to sample topics for particular users. In particular embodiments, the topic-to-content (T2C) predictor may work as an indexer. For each topic from the taxonomies, an indexer may be constructed to link the topic to a set of contents in the content pool which has such a topic. The weights of the connections may be stored along with the link showing how strong the topic is for the content. In particular embodiments, the system may manage the topic-content relationship using a topic-content graph as shown in FIG. 9. For a given content, the topics and the corresponding weights may be all from the content labeling component. In particular embodiments, the topic-to-content (T2C) prediction on a weighted bipartite graph may be essentially a weighted sampling as illustrated in FIG. 8B. For a given user, U2T predictor may provide a set of topics each associated with a weight, showing the sampled interests of the user. Each topic may index a set of contents with different weights. Thus, starting from these topics, the system may sample the connected contents, where the highly weighted edges lead to higher chance of being sampled. If a topic has higher weight from U2T, the system may have more samples get sampled from that topic. If a content is connected to multiple topics, the content may have a higher chance to be sampled, which makes sense as it better fits the user's interests. The system may dynamically determine and maintain the weight values for all related topics and the dynamically maintained weight values may be personalized for related users.

In particular embodiments, for content labeling, the system may use the content labelling component to detect, for each content in the content pool, a set of topics and the corresponding strength (confidence). For example, the system may determine that an article is 80% about traveling, 15% about culture, and 5% about cuisine. Depending on the taxonomy, the topics may be of multiple categories, ranging from concepts to emotions. The labeled contents together with the user engagement log may be used to determine user interest distributions which may be used by user-to-topic predictor to determine the interest topics for users. The labeled contents may also be used by the topic-content predictor to determine recommended contents based on interest topic of users.

For user engagement, the system may use a log related the recent activities of users, in terms of the engaged contents from the content pool, such as news articles, videos, photos, etc. The type of engagement may be also logged, such as view/watch, like-through, share, commenting, etc. For example, watch/view may be a weak type of engagement, while commenting or sharing may be stronger types of engagement. The different strengths or degree of relevance may affect the coordinates of a content node in the interest space as explained in the U2T predictor. It is notable that the system keeps all user engagement data, taxonomy data, and content control data of users at the local storage of the user's device to protect the user's privacy. Furthermore, the analysis and prediction are all performed locally within the user's device and the recommended contents are generated, processed and displayed only on the user's local device.

In particular embodiments, the system may use taxonomy or taxonomic classification as a scheme of classification, especially for a hierarchical classification, in which contents are organized into groups or types. Thus, the system may use taxonomy to offer info to compare the affinity of the topics. For example, “mammal” may be the parent of “dog”, which may be the parent of “husky.” In this context, taxonomy may be to support content labeling, that is, each concept or topic in the taxonomy may have a corresponding content understanding model in the content labeling component. It is notable that the system may not be bound to any specific taxonomy. For content pool, the system may have a set of contents to be considered, such as news articles, videos, etc. It is notable that in many recent apps, the content pool may be huge, for example, including billions of contents, and also may be very dynamic. For example, on social media platforms, many producers may actively upload new content. As a result, a video usually may not stay in the pool for more than two weeks.

In particular embodiments, the system may use topic controllable personalization for generating recommended content for users. Personalization in this context may be non-trivial in the system because it may need to incorporate topic control and handle the large scale users. For incorporating topic control, the user interest may be learned from the users' recent engagement and transform the information into the distribution in the interest space spanned by the topics. Since topics may be human-readable, the user's interest distribution may be interpretable and explainable. More specifically, a user can add new topics (if the user wants to see, but not yet engaged in the history) by augmenting the learned distribution. A user may filter out topics (if the user engaged such content but decides not to see more) by marginalizing the learned distribution in the interest space. It is notable that taxonomy may give hierarchical relationships among topics. When a topic is eliminated, the system may also eliminate the subtopics under that topic. It is notable that the system keeps all user engagement data, taxonomy data, and content control data of users at the local storage of the user's device to protect the user's privacy. Furthermore, the analysis and prediction are all performed locally within the user's device and the recommended contents are generated, processed and displayed only on the user's local device.

For handling the large scale users, it is worth noting that the interest distribution may be independent from one user to another. Assuming the user population is large, the system may scale out the user interest analysis and U2T prediction. For casual users, since the engagement is sparse, it may be challenging to estimate the distribution in the interest space. In such a case, rather than estimating the distribution of the user's interest, the system may simply count the occurrence of the topics from the engaged contents, which is mathematically equivalent to calculate the histogram of the topics. For new users without much available engaged content, the system may find the user's community (i.e. similar users) and assign the average distribution of the users in the community as the estimate (i.e. interpolation). To protect the user's privacy, all user engagement data, taxonomy data, and content control data are kept within users' local devices.

In particular embodiments, for the massive dynamic contents, the contents may be effectively indexed for efficient recommendation. The topic controllable personalization mentioned above may allow the system to sample a set of topics falling into the interests of the user (i.e. U2T prediction). To complete the recommendation, the intermediate results from U2T may be further processed by performing the T2C prediction to get a set of relevant contents for the given user (i.e. U2C).

FIG. 9 illustrates an example topic-content graph 4300 showing corresponding relationship and weights. In particular embodiments, the topic-to-content (T2C) predictor may work as an indexer. For each topic from the taxonomies, an indexer may be constructed to link the topic to a set of contents in the content pool which has such a topic. The weights of the connection may be stored along with the link showing how strong the topic is for the content. In particular embodiments, the system may manage the topic-content relationship using a topic-content graph as shown in FIG. 9. For a given content, the topics and the corresponding weights may be determined by the content labeling component. For example, the topic 4301 may be associated with the contents 4311, 4312, and 4313 with the content 4313 having the highest weight, as represented by the thicker line linking the topic 4301 and 4313. As another example, the topic 4302 may be associated with the content 4314. As another example, the topic 4303 may be associated with the contents 4311, 4313, 4315, 4318, and 4320 with the content 4311 having the highest weight, as represented by the thicker line linking the topic 4303 and 4311. As another example, the topic 4304 may be associated with the contents 4314, 4317, and 4319 with the contents 4314 and 4319 having the higher weights, as represented by the thicker lines. As another example, the topic 4305 may be associated with the contents 4316, 4318, and 4320 with the content 4320 having a relative higher weight, as represented by the thicker line.

In particular embodiments, the system may effectively handle dynamics in the content pool and the recommended content. It is notable that the topic nodes in the bipartite graph may be provided by the input taxonomy, which is relatively stable. The dynamics may mainly come from the contents due to the high volume of new creation and relatively short life span, plus the evolving weights between users and topics to reflect the recent engagement. In the bipartite graph representation, adding/expiring contents may become adding/deleting nodes and edges, which are the basic graph data management operations, with high throughput solutions available in graph runtime libraries or graph databases. It is notable that, in some applications, the number of topics may be orders of magnitude less than the number of contents, which can result in some high degree nodes of topics in the bipartite graph. Usually, higher node degree may result in lower efficiency in sampling the neighbor nodes. This may be mitigated by leveraging the advanced sampling techniques such as Alias sampling and adapting it to the graph structure. This technique may allow the system to take a consistent time for sampling neighbors, regardless how many content nodes are connected to a topic node.

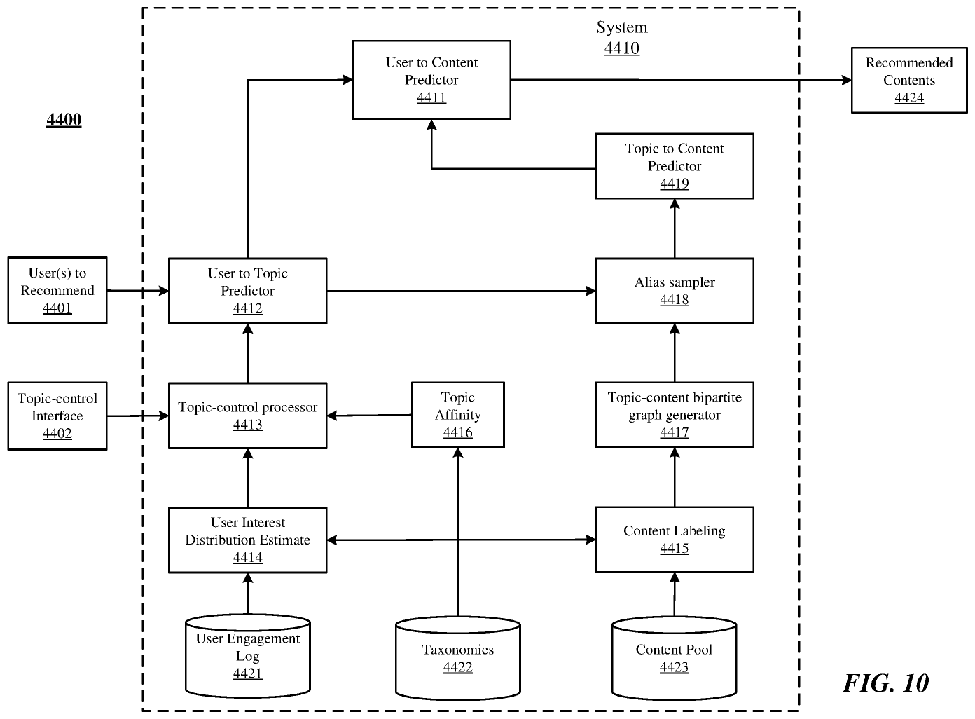

FIG. 10 illustrates an example system architecture and workflow 4400. In particular embodiments, the system may use the components and techniques as described in earlier sections of this disclosure for handling topic controllable personalization and for incorporating dynamics and massiveness of contents. Given the input from users or upstream systems (i.e. the users to make recommendation) and the optional topic control signals from the user agency, the recommendation system may perform the U2T and T2C predictions, using the methods, processes, principles, and techniques for handling topic-controllable personalization and for incorporating highly dynamic and massive content pool to generate the recommendation for the users. The system may output the relevant contents to the users' interests as well as fulfilling to the topic control requirements, such as what topics to see or not to see, which implements the U2C prediction.

As an example and not by way of limitation, the system may have two types of inputs: the users to whom the recommendations will be made (e.g., 4401) and the users input from the topic control interface 4402 (e.g., users' setting of content control). The user may specify particular topics to be included or excluded from the recommendations. The system 4410 may be implemented locally within the user's device so that all the related data (e.g., user engagement logs, taxonomy, the content pool) and the analysis, processing and recommending process are performed locally within the user's device to protect the privacy of the user. The system 4410 may use the content labelling component 4415 to detect, for each content in the content pool 4423, a set of topics and the corresponding strength (confidence) of each topic with respect to the content (e.g., a relevance metric). For example, the system may determine that an article is 80% about traveling, 15% about culture, and 5% about cuisine. Depending on the taxonomy, the topics may be of multiple categories. The labeled contents together with the user engagement log 4421 may be used to determine user interest distribution estimation 4414. The user input through the topic-control interface 4402 may be fed into the topic-control processor 4413 which may include or exclude particular topics from the user interest distribution estimation 4414. The topic affinity component 4416 may access the taxonomy data 4422 and determine the topic affinity of different classifications. The topic-control processor 4413 may further exclude or include related topics based on the topic affinity information determined by the topic affinity component 4416. The labeled contents may also be used by the topic-content predictor to determine recommended contents based on interest topic of users.

The system may use the user to topics predictor 4412 to determine the personalized topic recommendations. As discussed earlier, the system may determine interest distribution which may include a number of topics from the user's engagement log, the user topic-control inputs, the classifications, the labeled content, etc. The system may determine a set of personalized weights for the related topics and may use the weighted topics to determine the recommended topics and contents for the users. The personalized topics generated by the user to topic predictor 4412 may be fed into the user to content predictor 4411 for generating the recommended contents 4424.

For another branch of path in the workflow 4400, the labelled contents generated by the content labeling component 4415 may be fed into the topic content bipartite generator 4417 to generate topic-content graphs. A topic-content graph may include a number of topic nodes, each representing a topic, and a number of content nodes, each representing a content. The topic nodes and the content nodes may be connected by the links each presenting an association or relationship between the connected topic node and content node. Each link may be associated with a weight and may reflect that weight by the width of the link (e.g., as shown in FIG. 9). After the topic-content graph has been generated, the graph and the recommended topics that are generated by the user to topic predictor 4412 may be fed into the Alias sampler 4418, which may perform the Alias sampling on the topics and the contents in the topic-content graphs. As discussed earlier, the system may determine a set of personalized weights for the topics and sample the topics based on these weights. A topic with a higher weight may be sampled more than a topic with a lower weight. The sampled results by the Alias sampler 4418 may be fed into the topic to content predictor 4419. The outputs of the topic to content predictor 4419 and the outputs of the user to topic predictor 4412 may be fed into the user to content predictor 4411, which may in turn generate the recommended content for the user.

In particular embodiments, the systems, methods, processes, and principles may be partially used for the recommendation system (more specifically, the organic source for retrieval) for social media platforms or/and search engines. In particular embodiments, the topic-controllable personalized recommendation system on massive dynamic contents may have one or more features as described herein. First, the system may have a topic control interface available to user. To support topic control, the system may use some interface to interact with users, so that topics derived from a user's recent engagements can be displayed and users can make modifications on such topics. Second, the system may have some topics learned from recent engagement. Controllable personalization may have a user's interest topics learned from the recent engagement. Thus, by intentionally interacting with contents of certain topics for a while, such topics may appear in the topic control interface. Third, the system may use Alias sampling to improve sampling efficiency: Since Alias sampling has constant complexity, regardless of the number of contents indexed by a topic, the system may intentionally engage a set of contents of the same topic. The system may use T2C prediction efficiently using the increased number of engaged contents. Fourth, the system may use dynamic content update. The system framework may support dynamic updates of users' interest, by introducing a set of contents of the same topics and checking how long the new topic is capture by the recommendation system,

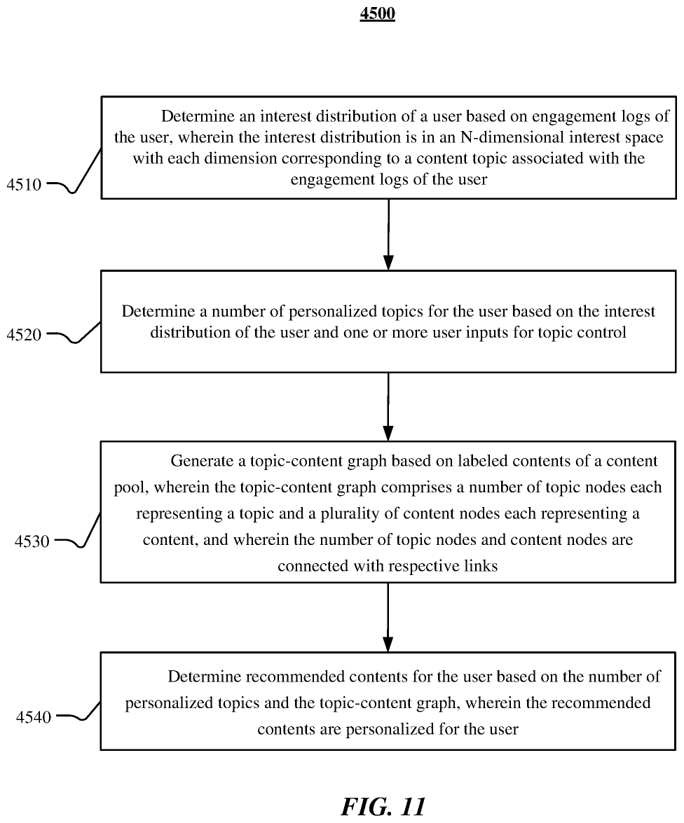

FIG. 11 illustrates an example method 4500 of generating personalized content recommendations for users. The method may begin at step 4510, where a computing system may determine an interest distribution of a user based on engagement logs of the user. The interest distribution may be in an N-dimensional interest space with each dimension corresponding to a content topic associated with the engagement logs of the user. At step 4520, the system may determine a number of personalized topics for the user based on the interest distribution of the user and one or more user inputs for topic control. At step 4530, the system may generate a topic-content graph based on labeled contents of a content pool. The topic-content graph may include a number of topic nodes each representing a topic and a number of content nodes each representing a content. The topic nodes and content nodes may be connected with respective links. At step 4540, the system may determine recommended contents for the user based on the personalized topics and the topic-content graph. The recommended contents may be personalized for the user. In particular embodiments, the personalized topics may be determined based on affinity analyzing results and a number of content classifications accessed from a taxonomy database. The personalized topics may be determined by a user-to-topic predictor.

In particular embodiments, one or more computing systems may access first data associated with a first user. The system may determine, based on the first data associated with the first user, a plurality of content recommendations for the first users. The plurality of content recommendations may be associated with one or more interests or one or more interactions of the first user with a social network platform. The system may execute one or more operations associated with the plurality of content recommendations, the one or more operations causing one or more contents to be displayed to the first user.

In particular embodiments, the system may determine grouping information associated with a plurality of first tabs grouped by the first user. The system may determine contents of interaction contexts and the plurality of first tabs in which the first user interacts with the plurality of first tabs. The system may use the grouping information, the contents, and the interaction contexts associated with the plurality of first tabs to train a machine-learning model to process content and interaction context associated with a tab to generate an embedding in a d-dimensional embedding space to represent the tab. The system may generate, for each of a plurality of second tabs, the embedding in the d-dimensional embedding space using the trained machine-learning model. The system may group the plurality of second tabs based on the embeddings of the plurality of second tabs.

In particular embodiment, a server of an online content provider may receive, from an advertiser, information related to the advertiser and an advertisement; The server may receive, from the advertiser, a bid amount to make the advertisement viewable by users of the online content provider. The server may allow the first user to access the server of the online content provider to view options for filtering advertisements displayed by the online content provider and information indicating credit amounts that the first user would earn by watching advertisements displayed by the online content provider. The server may receive, from the first user, filter selections for advertisements the first user wishes to watch while using a service provided by the online content provider. The filter selections may include the advertisement of the advertiser. The system may provide, to the first user, the advertisement made viewable by the advertiser. The system may send, to the first user, a credit for watching the advertisement. An amount of the credit earned by the first user may be related to the bid amount by the advertiser to make the advertisement viewable. The system may provide service or benefits to the first user based on the credit earned by the first user.

In particular embodiments, the system may determine, based on a recommendation ruleset, a set of recommended media items for display to the first user using a plurality of views. Each view of the plurality of views may be configured to display a subset of recommended media items in the set. The system may identify, for each of the plurality of views, a pair of media items in the subset of recommended media items associated with the view, the pair of media items having a highest similarity score among pairs of media items in the subset. The system may generate, based on a visual-diversity ruleset, visual-diversity scores for the plurality of views based on the highest similarity scores associated with the pairs of media items associated with the plurality of views.

In particular embodiments, the system may determine an interest distribution of the first user based on engagement logs of the first user. The interest distribution may be in an N-dimensional interest space with each dimension corresponding to a content topic associated with the engagement logs of the first user. The system may determine a plurality of personalized topics for the first user based on the interest distribution of the first user and one or more user inputs for topic control. The system may generate a topic-content graph based on labeled contents of a content pool. The topic-content graph may include a plurality of topic nodes each representing a topic and a plurality of content nodes each representing a content. The plurality of topic nodes and the plurality of content nodes may be connected with respective links. The system may determine recommended contents for the first user based on the plurality of personalized topics and the topic-content graph. The recommended contents may be personalized for the first user. The plurality of personalized topics may be determined based on affinity analyzing results one a plurality of content classifications accessed from a taxonomy database. The plurality of personalized topics may be determined by a user-to-topic predictor.

Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for generating personalized content recommendations for users including the particular steps of the method of FIG. 11, this disclosure contemplates any suitable method for generating personalized content recommendations for users including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

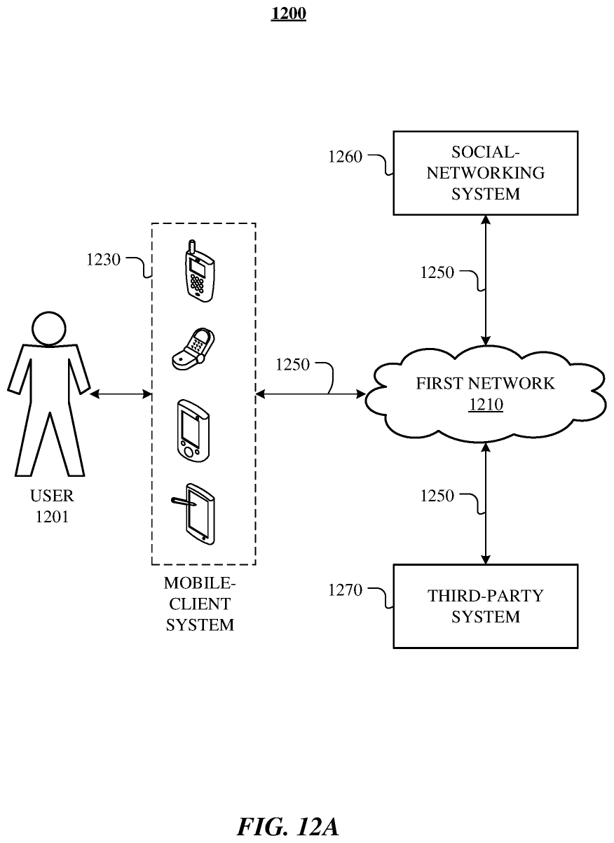

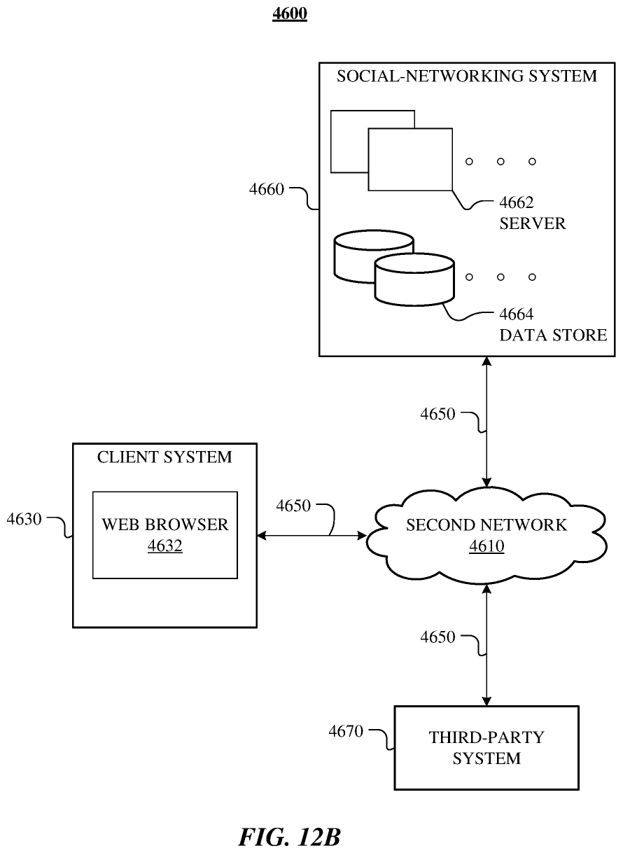

FIG. 12A illustrates an example network environment 1200 associated with a social-networking system. Network environment 1200 includes a user 1201, a client system 1230, a social-networking system 1260, and a third-party system 1270 connected to each other by a first network 1210. Although FIG. 12A illustrates a particular arrangement of user 1201, a client system 1230, a social-networking system 1260, a third-party system 1270, and a first network 1210, this disclosure contemplates any suitable arrangement of user 1201, client system 1230, social-networking system 1260, third-party system 1270, and first network 1210. As an example and not by way of limitation, two or more of client system 1230, social-networking system 1260, and third-party system 1270 may be connected to each other directly, bypassing first network 1210. As another example, two or more of client system 1230, social-networking system 1260, and third-party system 1270 may be physically or logically co-located with each other in whole or in part. Moreover, although FIG. 12A illustrates a particular number of users 1201, client systems 1230, social-networking systems 1260, third-party systems 1270, and networks 1210, this disclosure contemplates any suitable number of users 1201, client systems 1230, social-networking systems 1260, third-party systems 1270, and networks 1210. As an example and not by way of limitation, network environment 1200 may include multiple users 1201, client system 1230, social-networking systems 1260, third-party systems 1270, and networks 1210.

In particular embodiments, user 1201 may be an individual (human user), an entity (e.g., an enterprise, business, or third-party application), or a group (e.g., of individuals or entities) that interacts or communicates with or over social-networking system 1260. In particular embodiments, social-networking system 1260 may be a network-addressable computing system hosting an online social network. Social-networking system 1260 may generate, store, receive, and send social-networking data, such as, for example, user-profile data, concept-profile data, social-graph information, or other suitable data related to the online social network. Social-networking system 1260 may be accessed by the other components of network environment 1200 either directly or via first network 1210. In particular embodiments, social-networking system 1260 may include an authorization server (or other suitable component(s)) that allows users 1201 to opt in to or opt out of having their actions logged by social-networking system 1260 or shared with other systems (e.g., third-party systems 1270), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 1230 through blocking, data hashing, anonymization, or other suitable techniques as appropriate. In particular embodiments, third-party system 1270 may be a network-addressable computing system that can host content providers providing advertisements for viewing. Third-party system 1270 may generate, store, receive, and send advertisements along with corresponding advertiser and business information, such as, for example, data required to display advertisements for various products or services along with service and content provider information. Third-party system 1270 may be accessed by the other components of network environment 1200 either directly or via first network 1210. In particular embodiments, one or more users 1201 may use one or more client systems 1230 to access, send data to, and receive data from social-networking system 1260 or third-party system 1270. Client system 1230 may access social-networking system 1260 or third-party system 1270 directly, via first network 1210, or via a third-party system. As an example and not by way of limitation, client system 1230 may access third-party system 1270 via social-networking system 1260. Client system 1230 may be any suitable computing device, such as, for example, a personal computer, a laptop computer, a cellular telephone, a smartphone, a tablet computer, or an augmented/virtual reality device.

This disclosure contemplates any suitable first network 1210. As an example and not by way of limitation, one or more portions of first network 1210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. First network 1210 may include one or more networks 1210.

Links 1250 may connect client system 1230, social-networking system 1260, and third-party system 1270 to communication first network 1210 or to each other. This disclosure contemplates any suitable links 1250. In particular embodiments, one or more links 1250 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1250 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1250, or a combination of two or more such links 1250. Links 1250 need not necessarily be the same throughout network environment 1200. One or more first links 1250 may differ in one or more respects from one or more second links 1250.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social-networking system 1260 or shared with other systems (e.g., third-party system 1270). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 1270, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 1260 may send a request to the data store for the object. The request may identify the user associated with the request and may only be sent to the user (or a client system 1230 of the user) if the authorization server determines that the user is authorized to access the object based on the privacy settings associated with the object. If the requesting user is not authorized to access the object, the authorization server may prevent the requested object from being retrieved from the data store, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

FIG. 12B illustrates an example network environment 4600 associated with a social-networking system. Network environment 4600 includes a client system 4630, a social-networking system 4660, and a third-party system 4670 connected to each other by a second network 4610. Although FIG. 12B illustrates a particular arrangement of client system 4630, social-networking system 4660, third-party system 4670, and second network 4610, this disclosure contemplates any suitable arrangement of client system 4630, social-networking system 4660, third-party system 4670, and second network 4610. As an example and not by way of limitation, two or more of client system 4630, social-networking system 4660, and third-party system 4670 may be connected to each other directly, bypassing second network 4610. As another example, two or more of client system 4630, social-networking system 4660, and third-party system 4670 may be physically or logically co-located with each other in whole or in part. Moreover, although FIG. 12B illustrates a particular number of client systems 4630, social-networking systems 4660, third-party systems 4670, and networks 4610, this disclosure contemplates any suitable number of client systems 4630, social-networking systems 4660, third-party systems 4670, and networks 4610. As an example and not by way of limitation, network environment 4600 may include multiple client system 4630, social-networking systems 4660, third-party systems 4670, and networks 4610.

This disclosure contemplates any suitable second network 4610. As an example and not by way of limitation, one or more portions of second network 4610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Second network 4610 may include one or more networks 4610.

Links 4650 may connect client system 4630, social-networking system 4660, and third-party system 4670 to communication second network 4610 or to each other. This disclosure contemplates any suitable links 4650. In particular embodiments, one or more links 4650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 4650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 4650, or a combination of two or more such links 4650. Links 4650 need not necessarily be the same throughout network environment 4600. One or more first links 4650 may differ in one or more respects from one or more second links 4650.

In particular embodiments, client system 4630 may be an electronic device including hardware, software, or embedded logic components or a combination of two or more such components and capable of carrying out the appropriate functionalities implemented or supported by client system 4630. As an example and not by way of limitation, a client system 4630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 4630. A client system 4630 may enable a network user at client system 4630 to access second network 4610. A client system 4630 may enable its user to communicate with other users at other client systems 4630.

In particular embodiments, client system 4630 may include a web browser 4632, and may have one or more add-ons, plug-ins, or other extensions. A user at client system 4630 may enter a Uniform Resource Locator (URL) or other address directing the web browser 4632 to a particular server (such as server 4662, or a server associated with a third-party system 4670), and the web browser 4632 may generate a Hyper Text Transfer Protocol (HTTP) request and communicate the HTTP request to server. The server may accept the HTTP request and communicate to client system 4630 one or more Hyper Text Markup Language (HTML) files responsive to the HTTP request. Client system 4630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 4660 may be a network-addressable computing system that can host an online social network. Social-networking system 4660 may generate, store, receive, and send social-networking data, such as, for example, user-profile data, concept-profile data, social-graph information, or other suitable data related to the online social network. Social-networking system 4660 may be accessed by the other components of network environment 4600 either directly or via second network 4610. As an example and not by way of limitation, client system 4630 may access social-networking system 4660 using a web browser 4632, or a native application associated with social-networking system 4660 (e.g., a mobile social-networking application, a messaging application, another suitable application, or any combination thereof) either directly or via second network 4610. In particular embodiments, social-networking system 4660 may include one or more servers 4662. Each server 4662 may be a unitary server or a distributed server spanning multiple computers or multiple datacenters. Servers 4662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 4662 may include hardware, software, or embedded logic components or a combination of two or more such components for carrying out the appropriate functionalities implemented or supported by server 4662. In particular embodiments, social-networking system 4660 may include one or more data stores 4664. Data stores 4664 may be used to store various types of information. In particular embodiments, the information stored in data stores 4664 may be organized according to specific data structures. In particular embodiments, each data store 4664 may be a relational, columnar, correlation, or other suitable database. Although this disclosure describes or illustrates particular types of databases, this disclosure contemplates any suitable types of databases. Particular embodiments may provide interfaces that enable a client system 4630, a social-networking system 4660, or a third-party system 4670 to manage, retrieve, modify, add, or delete, the information stored in data store 4664.

In particular embodiments, social-networking system 4660 may store one or more social graphs in one or more data stores 4664. In particular embodiments, a social graph may include multiple nodes—which may include multiple user nodes (each corresponding to a particular user) or multiple concept nodes (each corresponding to a particular concept)—and multiple edges connecting the nodes. Social-networking system 4660 may provide users of the online social network the ability to communicate and interact with other users. In particular embodiments, users may join the online social network via social-networking system 4660 and then add connections (e.g., relationships) to a number of other users of social-networking system 4660 to whom they want to be connected. Herein, the term “friend” may refer to any other user of social-networking system 4660 with whom a user has formed a connection, association, or relationship via social-networking system 4660.

In particular embodiments, social-networking system 4660 may provide users with the ability to take actions on various types of items or objects, supported by social-networking system 4660. As an example and not by way of limitation, the items and objects may include groups or social networks to which users of social-networking system 4660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 4660 or by an external system of third-party system 4670, which is separate from social-networking system 4660 and coupled to social-networking system 4660 via a second network 4610.

In particular embodiments, social-networking system 4660 may be capable of linking a variety of entities. As an example and not by way of limitation, social-networking system 4660 may enable users to interact with each other as well as receive content from third-party systems 4670 or other entities, or to allow users to interact with these entities through an application programming interfaces (API) or other communication channels.

In particular embodiments, a third-party system 4670 may include one or more types of servers, one or more data stores, one or more interfaces, including but not limited to APIs, one or more web services, one or more content sources, one or more networks, or any other suitable components, e.g., that servers may communicate with. A third-party system 4670 may be operated by a different entity from an entity operating social-networking system 4660. In particular embodiments, however, social-networking system 4660 and third-party systems 4670 may operate in conjunction with each other to provide social-networking services to users of social-networking system 4660 or third-party systems 4670. In this sense, social-networking system 4660 may provide a platform, or backbone, which other systems, such as third-party systems 4670, may use to provide social-networking services and functionality to users across the Internet.

In particular embodiments, a third-party system 4670 may include a third-party content object provider. A third-party content object provider may include one or more sources of content objects, which may be communicated to a client system 4630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 4660 also includes user-generated content objects, which may enhance a user's interactions with social-networking system 4660. User-generated content may include anything a user can add, upload, send, or “post” to social-networking system 4660. As an example and not by way of limitation, a user communicates posts to social-networking system 4660 from a client system 4630. Posts may include data such as status updates or other textual data, location information, photos, videos, links, music or other similar data or media. Content may also be added to social-networking system 4660 by a third-party through a “communication channel,” such as a newsfeed or stream.

In particular embodiments, social-networking system 4660 may include a variety of servers, sub-systems, programs, modules, logs, and data stores. In particular embodiments, social-networking system 4660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 4660 may also include suitable components such as network interfaces, security mechanisms, load balancers, failover servers, management-and-network-operations consoles, other suitable components, or any suitable combination thereof. In particular embodiments, social-networking system 4660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 4660 to one or more client systems 4630 or one or more third-party system 4670 via second network 4610. The web server may include a mail server or other messaging functionality for receiving and routing messages between social-networking system 4660 and one or more client systems 4630. An API-request server may allow a third-party system 4670 to access information from social-networking system 4660 by calling one or more APIs. An action logger may be used to receive communications from a web server about a user's actions on or off social-networking system 4660. In conjunction with the action log, a third-party-content-object log may be maintained of user exposures to third-party-content objects. A notification controller may provide information regarding content objects to a client system 4630. Information may be pushed to a client system 4630 as notifications, or information may be pulled from client system 4630 responsive to a request received from client system 4630. Authorization servers may be used to enforce one or more privacy settings of the users of social-networking system 4660. A privacy setting of a user determines how particular information associated with a user can be shared. The authorization server may allow users to opt in to or opt out of having their actions logged by social-networking system 4660 or shared with other systems (e.g., third-party system 4670), such as, for example, by setting appropriate privacy settings. Third-party-content-object stores may be used to store content objects received from third parties, such as a third-party system 4670. Location stores may be used for storing location information received from client systems 4630 associated with users. Advertisement-pricing modules may combine social information, the current time, location information, or other suitable information to provide relevant advertisements, in the form of notifications, to a user.

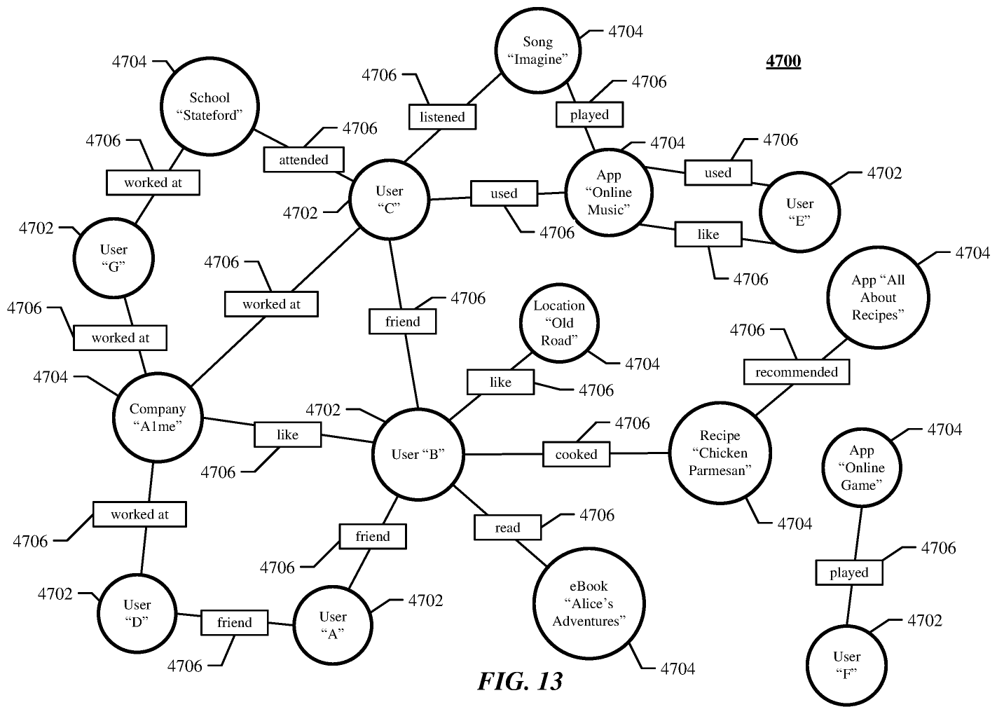

FIG. 13 illustrates example social graph 4700. In particular embodiments, social-networking system 4660 may store one or more social graphs 4700 in one or more data stores. In particular embodiments, social graph 4700 may include multiple nodes—which may include multiple user nodes 4702 or multiple concept nodes 4704—and multiple edges 4706 connecting the nodes. Each node may be associated with a unique entity (i.e., user or concept), each of which may have a unique identifier (ID), such as a unique number or username. Example social graph 4700 illustrated in FIG. 13 is shown, for didactic purposes, in a two-dimensional visual map representation. In particular embodiments, a social-networking system 4660, client system 4630, or third-party system 4670 may access social graph 4700 and related social-graph information for suitable applications. The nodes and edges of social graph 4700 may be stored as data objects, for example, in a data store (such as a social-graph database). Such a data store may include one or more searchable or queryable indexes of nodes or edges of social graph 4700.

In particular embodiments, a user node 4702 may correspond to a user of social-networking system 4660. As an example and not by way of limitation, a user may be an individual (human user), an entity (e.g., an enterprise, business, or third-party application), or a group (e.g., of individuals or entities) that interacts or communicates with or over social-networking system 4660. In particular embodiments, when a user registers for an account with social-networking system 4660, social-networking system 4660 may create a user node 4702 corresponding to the user, and store the user node 4702 in one or more data stores. Users and user nodes 4702 described herein may, where appropriate, refer to registered users and user nodes 4702 associated with registered users. In addition or as an alternative, users and user nodes 4702 described herein may, where appropriate, refer to users that have not registered with social-networking system 4660. In particular embodiments, a user node 4702 may be associated with information provided by a user or information gathered by various systems, including social-networking system 4660. As an example and not by way of limitation, a user may provide his or her name, profile picture, contact information, birth date, sex, marital status, family status, employment, education background, preferences, interests, or other demographic information. In particular embodiments, a user node 4702 may be associated with one or more data objects corresponding to information associated with a user. In particular embodiments, a user node 4702 may correspond to one or more webpages.

In particular embodiments, a concept node 4704 may correspond to a concept. As an example and not by way of limitation, a concept may correspond to a place (such as, for example, a movie theater, restaurant, landmark, or city); a website (such as, for example, a website associated with social-network system 4660 or a third-party website associated with a web-application server); an entity (such as, for example, a person, business, group, sports team, or celebrity); a resource (such as, for example, an audio file, video file, digital photo, text file, structured document, or application) which may be located within social-networking system 4660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 4704 may be associated with information of a concept provided by a user or information gathered by various systems, including social-networking system 4660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 4704 may be associated with one or more data objects corresponding to information associated with concept node 4704. In particular embodiments, a concept node 4704 may correspond to one or more webpages.

In particular embodiments, a node in social graph 4700 may represent or be represented by a webpage (which may be referred to as a “profile page”). Profile pages may be hosted by or accessible to social-networking system 4660. Profile pages may also be hosted on third-party websites associated with a third-party system 4670. As an example and not by way of limitation, a profile page corresponding to a particular external webpage may be the particular external webpage and the profile page may correspond to a particular concept node 4704. Profile pages may be viewable by all or a selected subset of other users. As an example and not by way of limitation, a user node 4702 may have a corresponding user-profile page in which the corresponding user may add content, make declarations, or otherwise express himself or herself. As another example and not by way of limitation, a concept node 4704 may have a corresponding concept-profile page in which one or more users may add content, make declarations, or express themselves, particularly in relation to the concept corresponding to concept node 4704.

In particular embodiments, a concept node 4704 may represent a third-party webpage or resource hosted by a third-party system 4670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 4630 to send to social-networking system 4660 a message indicating the user's action. In response to the message, social-networking system 4660 may create an edge (e.g., a check-in-type edge) between a user node 4702 corresponding to the user and a concept node 4704 corresponding to the third-party webpage or resource and store edge 4706 in one or more data stores.

In particular embodiments, a pair of nodes in social graph 4700 may be connected to each other by one or more edges 4706. An edge 4706 connecting a pair of nodes may represent a relationship between the pair of nodes. In particular embodiments, an edge 4706 may include or represent one or more data objects or attributes corresponding to the relationship between a pair of nodes. As an example and not by way of limitation, a first user may indicate that a second user is a “friend” of the first user. In response to this indication, social-networking system 4660 may send a “friend request” to the second user. If the second user confirms the “friend request,” social-networking system 4660 may create an edge 4706 connecting the first user's user node 4702 to the second user's user node 4702 in social graph 4700 and store edge 4706 as social-graph information in one or more of data stores 4664. In the example of FIG. 13, social graph 4700 includes an edge 4706 indicating a friend relation between user nodes 4702 of user “A” and user “B” and an edge indicating a friend relation between user nodes 4702 of user “C” and user “B.” Although this disclosure describes or illustrates particular edges 4706 with particular attributes connecting particular user nodes 4702, this disclosure contemplates any suitable edges 4706 with any suitable attributes connecting user nodes 4702. As an example and not by way of limitation, an edge 4706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 4700 by one or more edges 4706. The degree of separation between two objects represented by two nodes, respectively, is a count of edges in a shortest path connecting the two nodes in the social graph 4700. As an example and not by way of limitation, in the social graph 4700, the user node 4702 of user “C” is connected to the user node 4702 of user “A” via multiple paths including, for example, a first path directly passing through the user node 4702 of user “B,” a second path passing through the concept node 4704 of company “A1me” and the user node 4702 of user “D,” and a third path passing through the user nodes 4702 and concept nodes 4704 representing school “Stateford,” user “G,” company “A1me,” and user “D.” User “C” and user “A” have a degree of separation of two because the shortest path connecting their corresponding nodes (i.e., the first path) includes two edges 4706.

In particular embodiments, an edge 4706 between a user node 4702 and a concept node 4704 may represent a particular action or activity performed by a user associated with user node 4702 toward a concept associated with a concept node 4704. As an example and not by way of limitation, as illustrated in FIG. 13, a user may “like,” “attended,” “played,” “listened,” “cooked,” “worked at,” or “watched” a concept, each of which may correspond to an edge type or subtype. A concept-profile page corresponding to a concept node 4704 may include, for example, a selectable “check in” icon (such as, for example, a clickable “check in” icon) or a selectable “add to favorites” icon. Similarly, after a user clicks these icons, social-networking system 4660 may create a “favorite” edge or a “check in” edge in response to a user's action corresponding to a respective action. As another example and not by way of limitation, a user (user “C”) may listen to a particular song (“Imagine”) using a particular application (a third-party online music application). In this case, social-networking system 4660 may create a “listened” edge 4706 and a “used” edge (as illustrated in FIG. 13) between user nodes 4702 corresponding to the user and concept nodes 4704 corresponding to the song and application to indicate that the user listened to the song and used the application. Moreover, social-networking system 4660 may create a “played” edge 4706 (as illustrated in FIG. 13) between concept nodes 4704 corresponding to the song and the application to indicate that the particular song was played by the particular application. In this case, “played” edge 4706 corresponds to an action performed by an external application (the third-party online music application) on an external audio file (the song “Imagine”). Although this disclosure describes particular edges 4706 with particular attributes connecting user nodes 4702 and concept nodes 4704, this disclosure contemplates any suitable edges 4706 with any suitable attributes connecting user nodes 4702 and concept nodes 4704. Moreover, although this disclosure describes edges between a user node 4702 and a concept node 4704 representing a single relationship, this disclosure contemplates edges between a user node 4702 and a concept node 4704 representing one or more relationships. As an example and not by way of limitation, an edge 4706 may represent both that a user likes and has used at a particular concept. Alternatively, another edge 4706 may represent each type of relationship (or multiples of a single relationship) between a user node 4702 and a concept node 4704 (as illustrated in FIG. 13 between user node 4702 for user “E” and concept node 4704 for “online music application”).

In particular embodiments, social-networking system 4660 may create an edge 4706 between a user node 4702 and a concept node 4704 in social graph 4700. As an example and not by way of limitation, a user viewing a concept-profile page (such as, for example, by using a web browser or a special-purpose application hosted by the user's client system 4630) may indicate that he or she likes the concept represented by the concept node 4704 by clicking or selecting a “Like” icon, which may cause the user's client system 4630 to send to social-networking system 4660 a message indicating the user's liking of the concept associated with the concept-profile page. In response to the message, social-networking system 4660 may create an edge 4706 between user node 4702 associated with the user and concept node 4704, as illustrated by “like” edge 4706 between the user and concept node 4704. In particular embodiments, social-networking system 4660 may store an edge 4706 in one or more data stores. In particular embodiments, an edge 4706 may be automatically formed by social-networking system 4660 in response to a particular user action. As an example and not by way of limitation, if a first user uploads a picture, watches a movie, or listens to a song, an edge 4706 may be formed between user node 4702 corresponding to the first user and concept nodes 4704 corresponding to those concepts. Although this disclosure describes forming particular edges 4706 in particular manners, this disclosure contemplates forming any suitable edges 4706 in any suitable manner.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 4704 corresponding to a particular photo may have a privacy setting specifying that the photo may only be accessed by users tagged in the photo and their friends. In particular embodiments, privacy settings may allow users to opt in or opt out of having their actions logged by social-networking system 4660 or shared with other systems (e.g., third-party system 4670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 4670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 4662 may be authorization/privacy servers for enforcing privacy settings. In response to a request from a user (or other entity) for a particular object stored in a data store 4664, social-networking system 4660 may send a request to the data store 4664 for the object. The request may identify the user associated with the request and may only be sent to the user (or a client system 4630 of the user) if the authorization server determines that the user is authorized to access the object based on the privacy settings associated with the object. If the requesting user is not authorized to access the object, the authorization server may prevent the requested object from being retrieved from the data store 4664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

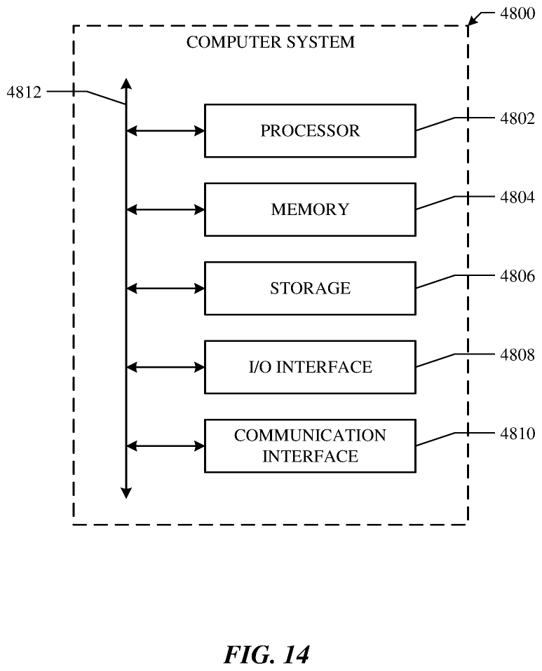

FIG. 14 illustrates an example computer system 4800. In particular embodiments, one or more computer systems 4800 perform one or more steps of one or more methods described or illustrated herein. In particular embodiments, one or more computer systems 4800 provide functionality described or illustrated herein. In particular embodiments, software running on one or more computer systems 4800 performs one or more steps of one or more methods described or illustrated herein or provides functionality described or illustrated herein. Particular embodiments include one or more portions of one or more computer systems 4800. Herein, reference to a computer system may encompass a computing device, and vice versa, where appropriate. Moreover, reference to a computer system may encompass one or more computer systems, where appropriate.

This disclosure contemplates any suitable number of computer systems 4800. This disclosure contemplates computer system 4800 taking any suitable physical form. As example and not by way of limitation, computer system 4800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, a Cloud virtual machine/container, or a combination of two or more of these. Where appropriate, computer system 4800 may include one or more computer systems 4800; be unitary or distributed; span multiple locations; span multiple machines; span multiple data centers; or reside in a cloud, which may include one or more cloud components in one or more networks. Where appropriate, one or more computer systems 4800 may perform without substantial spatial or temporal limitation one or more steps of one or more methods described or illustrated herein. As an example and not by way of limitation, one or more computer systems 4800 may perform in real time or in batch mode one or more steps of one or more methods described or illustrated herein. One or more computer systems 4800 may perform at different times or at different locations one or more steps of one or more methods described or illustrated herein, where appropriate.

In particular embodiments, computer system 4800 includes a processor 4802, memory 4804, storage 4806, an input/output (I/O) interface 4808, a communication interface 4810, and a bus 4812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 4802 includes hardware for executing instructions, such as those making up a computer program. As an example and not by way of limitation, to execute instructions, processor 4802 may retrieve (or fetch) the instructions from an internal register, an internal cache, memory 4804, or storage 4806; decode and execute them; and then write one or more results to an internal register, an internal cache, memory 4804, or storage 4806. In particular embodiments, processor 4802 may include one or more internal caches for data, instructions, or addresses. This disclosure contemplates processor 4802 including any suitable number of any suitable internal caches, where appropriate. As an example and not by way of limitation, processor 4802 may include one or more instruction caches, one or more data caches, and one or more translation lookaside buffers (TLBs). Instructions in the instruction caches may be copies of instructions in memory 4804 or storage 4806, and the instruction caches may speed up retrieval of those instructions by processor 4802. Data in the data caches may be copies of data in memory 4804 or storage 4806 for instructions executing at processor 4802 to operate on; the results of previous instructions executed at processor 4802 for access by subsequent instructions executing at processor 4802 or for writing to memory 4804 or storage 4806; or other suitable data. The data caches may speed up read or write operations by processor 4802. The TLBs may speed up virtual-address translation for processor 4802. In particular embodiments, processor 4802 may include one or more internal registers for data, instructions, or addresses. This disclosure contemplates processor 4802 including any suitable number of any suitable internal registers, where appropriate. Where appropriate, processor 4802 may include one or more arithmetic logic units (ALUs); be a multi-core processor; or include one or more processors 4802. Although this disclosure describes and illustrates a particular processor, this disclosure contemplates any suitable processor.

In particular embodiments, memory 4804 includes main memory for storing instructions for processor 4802 to execute or data for processor 4802 to operate on. As an example and not by way of limitation, computer system 4800 may load instructions from storage 4806 or another source (such as, for example, another computer system 4800) to memory 4804. Processor 4802 may then load the instructions from memory 4804 to an internal register or internal cache. To execute the instructions, processor 4802 may retrieve the instructions from the internal register or internal cache and decode them. During or after execution of the instructions, processor 4802 may write one or more results (which may be intermediate or final results) to the internal register or internal cache. Processor 4802 may then write one or more of those results to memory 4804. In particular embodiments, processor 4802 executes only instructions in one or more internal registers or internal caches or in memory 4804 (as opposed to storage 4806 or elsewhere) and operates only on data in one or more internal registers or internal caches or in memory 4804 (as opposed to storage 4806 or elsewhere). One or more memory buses (which may each include an address bus and a data bus) may couple processor 4802 to memory 4804. Bus 4812 may include one or more memory buses, as described below. In particular embodiments, one or more memory management units (MMUs) reside between processor 4802 and memory 4804 and facilitate accesses to memory 4804 requested by processor 4802. In particular embodiments, memory 4804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 4804 may include one or more memories 4804, where appropriate. Although this disclosure describes and illustrates particular memory, this disclosure contemplates any suitable memory.

In particular embodiments, storage 4806 includes mass storage for data or instructions. As an example and not by way of limitation, storage 4806 may include a hard disk drive (HDD), a floppy disk drive, flash memory, an optical disc, a magneto-optical disc, magnetic tape, or a Universal Serial Bus (USB) drive or a combination of two or more of these. Storage 4806 may include removable or non-removable (or fixed) media, where appropriate. Storage 4806 may be internal or external to computer system 4800, where appropriate. In particular embodiments, storage 4806 is non-volatile, solid-state memory. In particular embodiments, storage 4806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 4806 taking any suitable physical form. Storage 4806 may include one or more storage control units facilitating communication between processor 4802 and storage 4806, where appropriate. Where appropriate, storage 4806 may include one or more storages 4806. Although this disclosure describes and illustrates particular storage, this disclosure contemplates any suitable storage.

In particular embodiments, I/O interface 4808 includes hardware, software, or both, providing one or more interfaces for communication between computer system 4800 and one or more I/O devices. Computer system 4800 may include one or more of these I/O devices, where appropriate. One or more of these I/O devices may enable communication between a person and computer system 4800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 4808 for them. Where appropriate, I/O interface 4808 may include one or more device or software drivers enabling processor 4802 to drive one or more of these I/O devices. I/O interface 4808 may include one or more I/O interfaces 4808, where appropriate. Although this disclosure describes and illustrates a particular I/O interface, this disclosure contemplates any suitable I/O interface.

In particular embodiments, communication interface 4810 includes hardware, software, or both providing one or more interfaces for communication (such as, for example, packet-based communication) between computer system 4800 and one or more other computer systems 4800 or one or more networks. As an example and not by way of limitation, communication interface 4810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 4810 for it. As an example and not by way of limitation, computer system 4800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 4800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 4800 may include any suitable communication interface 4810 for any of these networks, where appropriate. Communication interface 4810 may include one or more communication interfaces 4810, where appropriate. Although this disclosure describes and illustrates a particular communication interface, this disclosure contemplates any suitable communication interface.

In particular embodiments, bus 4812 includes hardware, software, or both coupling components of computer system 4800 to each other. As an example and not by way of limitation, bus 4812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 4812 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, by one or more computing systems, comprising:
accessing first data associated with a first user;
determining, based on the first data associated with the first user, a plurality of content recommendations for the first users, the plurality of content recommendations being associated with one or more interests or one or more interactions of the first user with a social network platform; and
executing one or more operations associated with the plurality of content recommendations, the one or more operations causing one or more contents to be displayed to the first user.

2. The method of claim 1, further comprising:
determining grouping information associated with a plurality of first tabs grouped by the first user;
determining contents of interaction contexts and the plurality of first tabs in which the first user interacts with the plurality of first tabs;
using the grouping information, the contents, and the interaction contexts associated with the plurality of first tabs to train a machine-learning model to process content and interaction context associated with a tab to generate an embedding in a d-dimensional embedding space to represent the tab;
generating, for each of a plurality of second tabs, the embedding in the d-dimensional embedding space using the trained machine-learning model; and
grouping the plurality of second tabs based on the embeddings of the plurality of second tabs.

3. The method of claim 1 further comprising, by a server of an online content provider:
receiving, from an advertiser, information related to the advertiser and an advertisement;
receiving, from the advertiser, a bid amount to make the advertisement viewable by users of the online content provider;
allowing the first user to access the server of the online content provider to view options for filtering advertisements displayed by the online content provider and information indicating credit amounts that the first user would earn by watching advertisements displayed by the online content provider;
receiving, from the first user, filter selections for advertisements the first user wishes to watch while using a service provided by the online content provider, wherein the filter selections include the advertisement of the advertiser;
providing, to the first user, the advertisement made viewable by the advertiser;
sending, to the first user, a credit for watching the advertisement, wherein an amount of the credit earned by the first user is related to the bid amount by the advertiser to make the advertisement viewable; and
providing service or benefits to the first user based on the credit earned by the first user.

4. The method of claim 1, further comprising:
determining, based on a recommendation ruleset, a set of recommended media items for display to the first user using a plurality of views, wherein each view of the plurality of views is configured to display a subset of recommended media items in the set;
identifying, for each of the plurality of views, a pair of media items in the subset of recommended media items associated with the view, the pair of media items having a highest similarity score among pairs of media items in the subset; and
generating, based on a visual-diversity ruleset, visual-diversity scores for the plurality of views based on the highest similarity scores associated with the pairs of media items associated with the plurality of views.

5. The method of claim 1, further comprising:
determining an interest distribution of the first user based on engagement logs of the first user, wherein the interest distribution is in an N-dimensional interest space with each dimension corresponding to a content topic associated with the engagement logs of the first user;
determining a plurality of personalized topics for the first user based on the interest distribution of the first user and one or more user inputs for topic control;
generating a topic-content graph based on labeled contents of a content pool, wherein the topic-content graph comprises a plurality of topic nodes each representing a topic and a plurality of content nodes each representing a content, and wherein the plurality of topic nodes and the plurality of content nodes are connected with respective links; and
determining recommended contents for the first user based on the plurality of personalized topics and the topic-content graph, wherein the recommended contents are personalized for the first user.

6. The method of claim 5, wherein the plurality of personalized topics are determined based on affinity analyzing results one a plurality of content classifications accessed from a taxonomy database.

7. The method of claim 5, wherein the plurality of personalized topics are determined by a user-to-topic predictor.
